(19) United States
(12) Patent Application Publication
(10) Pub. No.: US 2016/0075823 A1
(43) Pub. Date: Mar. 17, 2016

(54) POLYCARBONATE MOLDED ARTICLE

(71) Applicant: TEIJIN LIMITED, Osaka-shi, OSAKA (JP)

(72) Inventors: Kenta IMAZATO, Ehime (JP); Tsuyoshi TAKEDA, Ehime (JP); Hiroshi OKAMOTO, Ehime (JP); Tetsuya MOTOYOSHI, Ehime (JP); Takushi TANI, Ehime (JP); Katsuhiro YAMANAKA, Ehime (JP)

(21) Appl. No.: 14/759,327

(22) PCT Filed: Feb. 21, 2014
(86) PCT No.: PCT/JP2014/054985

§ 371 Date: Jul. 6, 2015

(30) Foreign Application Priority Data
Feb. 26, 2013 (JP) 2013-035919
Feb. 26, 2013 (JP) 2013-035920
Mar. 1, 2013 (JP) 2013-040646

(51) Int. Cl. C08G 64/00; G02B 1/04

(52) U.S. Cl. CPC C08G 64/00; G02B 1/041

(57) ABSTRACT

A molded article such as a resin window or a lamp lens for vehicles which is formed from a polycarbonate and excellent in heat resistance, weather resistance, low water absorption, surface hardness and low-temperature impact properties.

The molded article is formed from a polycarbonate which contains a unit (A) represented by the following formula (A) in an amount of 50 mol % or more based on the total of all recurring units and has a maximum impact energy of 20 J or more in a high-speed surface impact test based on ASTM D3763 in a −20° C. environment and a brittle fracture rate of 50% or less.

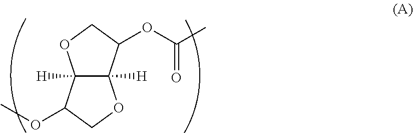

### TECHNICAL FIELD

The present invention relates to a molded article such as a resin window, a lamp lens for vehicles or a plastic lens which is formed from a polycarbonate and excellent in heat resistance, weather resistance, low-temperature properties, low water absorption and surface hardness.

### BACKGROUND ART

Since polycarbonates have excellent mechanical properties and optical properties, their application for molded articles such as resin windows, lamp lenses for vehicles and plastic lenses is now under study. Typical examples of the polycarbonates include polycarbonates obtained from bisphenol A.

However, due to concerns about the depletion of oil resources and an increasing amount of carbon dioxide in the air causing global warming, a great deal of attention is now paid to biomass resources whose raw materials do not depend on oil and which materialize “carbon neutral” without increasing the amount of carbon dioxide even when they are burnt. Use of isosorbide which is a biomass resource as a raw material for polycarbonates is now under study (Patent Document 1).

As a proposal for using a polycarbonate in a resin window, Patent Document 2 discloses that a polycarbonate obtained from bisphenol A is used in a resin window. However, this resin window is inferior in weather resistance. Patent Document 3 proposes use of a polycarbonate obtained from isosorbide in a resin window. However, this polycarbonate has a high water absorption coefficient and poor low-temperature impact properties, all of which must be improved.

As proposals for using a polycarbonate in a lamp lens for vehicles, Patent Document 4 and Patent Document 5 teach that a polycarbonate obtained by copolymerizing isosorbide with an aliphatic diol is used in a lamp lens for vehicles. However, since 1,4-cyclohexanedimethanol is used as the aliphatic diol, this polycarbonate has low physical properties at a low temperature, for example, low impact strength, whereby its use in cold districts is limited. Further, as it has a high water absorption coefficient, a dimensional change or warp occurs in its molded article by water absorption.

While polycarbonates obtained from isosorbide have been studied, they do not have good balance among characteristic properties such as heat resistance, surface hardness, low water absorption, low-temperature properties and weather resistance, all of which are required for resin windows and lamp lenses for vehicles.

Meanwhile, polycarbonates obtained from bisphenol A are widely used as materials for plastic lenses. However, as these polycarbonates have a high refractive index of 1.585 but a small Abbe's number of 30, they tend to have a chromatic aberration problem and bad balance between refractive index and Abbe's number. Further, they have a large photoelastic constant, resulting in the large birefringence of molded articles thereof disadvantageously.

To overcome the above defects of the polycarbonates, a copolycarbonate of a bisphenol and an aliphatic diol is proposed (Patent Document 6). However, since this polycarbonate has a low refractive index, a small Abbe's number and a large photoelastic constant, it provides a molded article having large birefringence. Further, it is unsatisfactory in terms of moldability, heat resistance and color, thereby making it impossible to obtain a satisfactory molded article.

A polycarbonate containing isosorbide is proposed as a material for plastic lenses which satisfies the above requirements and has a sufficiently high refractive index, a large Abbe's number and a small photoelastic constant as well as excellent physical properties and solvent resistance (Patent Documents 7, 8 and 9). However, it is hardly said that this polycarbonate has impact resistance high enough to be used in the field in which safety is required. Its impact strength at a low temperature is not investigated.

Further, as plastic lenses are lightweight and have excellent characteristic properties such as fashionability and impact resistance, they are rapidly spreading to the field of optical materials, especially spectacle lenses. Problems such as low surface hardness and surface reflection which have been considered as the defects of plastic materials have been significantly improved by the development of surface modification technology in which a silicone-based hard coat film is formed and an antireflection film obtained by vapor depositing an inorganic material on the surface of a lens is formed, whereby the market of plastic lenses is expanding due to high-value addition to lenses.

However, when a silicone-based hard coat or an inorganic antireflection film is formed, there occurs a problem that impact resistance inherent in a plastic lens sharply degrades. It is known that when, for example, allyl diglycol carbonate which is a generally-purpose thermosetting plastic lens material is used as a material, the impact resistance (in a falling ball test in which a steel ball having a predetermined weight is dropped from a height of 127 cm on the center of a lens having a center thickness of 2 mm) of a substrate itself is about 200 g but drops to about 60 g in the case of the formation of a hard coat on the substrate and to 10 g in the case of the formation of an antireflection film on the hard coat. To avoid this problem, in the case of a thermosetting plastic lens, there is disclosed a method for improving impact resistance by forming a primer layer between a plastic lens substrate and a silicone-based hard coat. It is disclosed that a spectacle lens having impact resistance and passing the U.S. FDA standard (falling ball impact value of 16.4 g) even after inorganic antireflection coating is obtained, for example, by a method for forming a urethane-based resin layer as the primer layer (Patent Document 10). However, for use in fields in which high safety is required, such as education and engineering, a plastic lens must pass ANSI Z87.1 standard (falling ball impact value of 68 g).

Prior Art Documents

| | |
|---|---|
| (Patent Document 1) | WO2004/111106 |
| (Patent Document 2) | JP-A 2003-311908 |
| (Patent Document 3) | JP-A 2009-61762 |
| (Patent Document 4) | JP-A 2009-144014 |
| (Patent Document 5) | JP-A 2012-41471 |
| (Patent Document 6) | JP-A 2003-090901 |
| (Patent Document 7) | JP-A 2009-62501 |
| (Patent Document 8) | JP-A 2009-63976 |
| (Patent Document 9) | JP-A 2010-190919 |
| (Patent Document 10) | JP-A 08-54501 |

### DISCLOSURE OF THE INVENTION

It is another object of the present invention to provide a molded article such as a resin window or a lamp lens for vehicles which is formed from a polycarbonate and excellent in heat resistance, weather resistance, low water absorption, surface hardness and low-temperature impact properties.

The inventors of the present invention conducted intensive studies and found that a polycarbonate containing a unit derived from isosorbide has a low moisture absorption coefficient and excellent low-temperature impact properties. The present invention was accomplished based on this finding.

That is, the present invention is a molded article formed from a polycarbonate which contains a unit (A) represented by the following formula in an amount of 50 mol % or more based on the total of all recurring units and has a maximum impact energy of 20 J or more in a high-speed surface impact test based on ASTM D3763 in a −20° C. environment and a brittle fracture rate of 50% or less. The molded article is preferably a resin window or a lamp lens for vehicles.

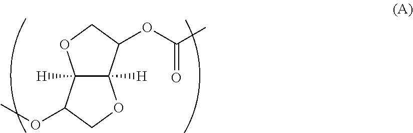

It is another object of the present invention to provide a plastic lens having good balance among heat resistance, cold resistance, transparency, impact strength, scratch resistance and optical properties. The inventors of the present invention found that a polycarbonate containing a unit derived from isosorbide has good balance among heat resistance, cold resistance, transparency, impact strength, scratch resistance and optical properties and accomplished the present invention.

That is, the present invention is a plastic lens which is formed from a polycarbonate containing (i) a carbonate unit (A) represented by the following formula and having (ii) a specific viscosity measured with a 20° C. methylene chloride solution of 0.3 to 0.8, (iii) a glass transition temperature of 100° C. or higher, (iv) a pencil hardness of at least HB and (v) a total light transmittance of 80% or more and which (vi) does not crack with a falling ball having a weight of at least 68 g in a falling ball test based on ANSI Z87.1 standard at 25° C. and (vii) has an in-plane phase difference of 50 nm or less at a thickness of 2.0 mm.

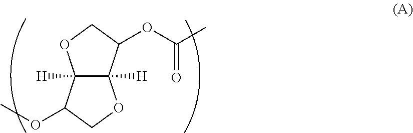

### BRIEF DESCRIPTION OF THE DRAWINGS

FIG. 1 show a car plain head lamp lens molded article formed in Example. The lens is dome-shaped as shown in the figures. [1-A] is a front view (projected on a platen surface at the time of molding. Therefore, the area is the largest projection area.), and [1-B] is a cross-sectional view cut on line A-A.

### BEST MODE FOR CARRYING OUT THE INVENTION

The present invention will be described in detail hereinbelow.

### <Molded Article>

The polycarbonate used in the present invention has a unit (A) content of 50 mol % or more, preferably 60 mol % or more, more preferably 70 mol % or more, much more preferably 80 mol % or more based on the total of all the recurring units.

### (Unit (A)

The unit (A) in the present invention is derived from an aliphatic diol having an ether group. The diol having an ether bond is a material having high heat resistance and high pencil hardness among biomass resources.

Examples of the unit (A) include units (A1), (A2) and (A3) which are stereoisomeric to one another.

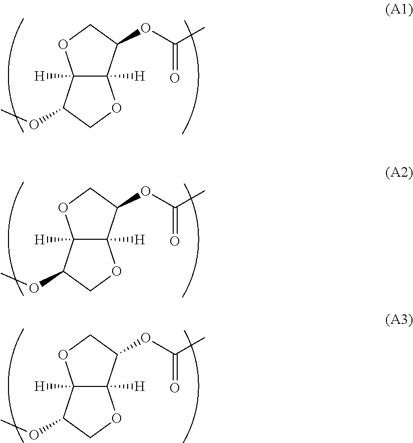

They are units derived from sugar-derived ether diols, obtained from the biomass of the natural world and called “renewable resources”. The units (A1), (A2) and (A3) are units derived from isosorbide, isommanide and isoidide, respectively. Isosorbide is obtained by hydrogenating D-glucose obtained from starch and dehydrating the obtained product. The other ether diols are obtained from a similar reaction except for the starting material.

The recurring unit derived from isosorbide (1,4:3,6-dianhydro-D-sorbitol) out of isosorbide, isomannide and isoidide is particularly preferred because it is easily produced and has excellent heat resistance.

Preferred examples of the polycarbonate which is used in the present invention include (1) a copolycarbonate containing a unit derived from a long-chain aliphatic diol, (2) a copolycarbonate having a block structure, (3) a copolycarbonate having a side chain and (4) a copolycarbonate containing a unit derived from a polyester diol.

(copolycarbonate (1)) A preferred example of the polycarbonate which is used in the present invention is a copolycarbonate (1) which contains the unit (A) and a unit (B-1) represented by the following formula and has (i) a total content of the unit (A) and the unit (B-1) of 80 mol % or more based on the total of all the recurring units and (ii) a (A/(B-1)) molar ratio of the unit (A) to the unit (B-1) of 60/40 to 95/5.

The copolycarbonate (1) contains a unit derived from a long-chain aliphatic diol.

The total content of the unit (A) and the unit (B-1) is preferably 90 mol % or more, more preferably 95 mol % or more, much more preferably 100 mol % based on the total of all the recurring units.

The (A/(B-1)) molar ratio of the unit (A) to the unit (B-1) is preferably 70/30 to 93/7, more preferably 80/20 to 90/10. Within the above range, balance among heat resistance, weather resistance, low water absorption, surface hardness and low-temperature impact properties becomes excellent advantageously. The (A/(B-1)) molar ratio can be calculated by measurement with the proton NMR of JNM-AL400 of JEOL Ltd.

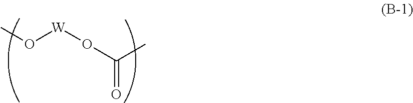

In the above formula, W is an alkylene group having 8 to 12 carbon atoms. Examples of the alkylene group having 8 to 12 carbon atoms include octylene group, nonylene group, decylene group and dodecylene group.

The unit (B-1) is derived from an aliphatic diol having 8 to 12 carbon atoms. Examples of the aliphatic diol having 8 to 12 carbon atoms include 1,8-octanediol, 1,9-nonanediol, 1,10-decanediol, 1,12-dodecanediol, 2,4-diethyl-1,5-pentanediol and 2-methyl-1,8-octanediol. Out of these, 1,8-octanediol, 1,9-nonanediol, 1,10-decanediol and 1,12-dodecanediol are preferred, and 1,9-nonanediol, 1,10-decanediol and 1,12-dodecanediol are more preferred. They may be used in combination of two or more.

A diol compound inducing a unit except for the unit (A) and the unit (B-1) may be any one of monomer compounds inducing a unit (B-2) and a unit (B-3) which will be described hereinafter, and aliphatic diol compounds, alicyclic diol compounds and aromatic dihydroxy compounds except for these monomer compounds. Specific examples of the diol compound include diol compounds and oxyalkylene glycols such as diethylene glycol, triethylene glycol, tetraethylene glycol and polyethylene glycol described in the pamphlet of WO2004/111106 and the pamphlet of WO2011/021720.

The aliphatic dihydroxy compounds include 1,3-propanediol, 1,4-butanediol, 1,5-pentanediol and 1,6-hexanediol.

The alicyclic dihydroxy compounds include cyclohexanedimethanol, tricyclodecanedimethanol, adamantanediol, pentacyclopentadecanedimethanol and 3,9-bis(2-hydroxy-1,1-diemthylethyl)-2,4,8,10-tetraoxaspiro[5.5]undecane.

The aromatic dihydroxy compounds include α,α′-bis(4-hydroxyphenyl)-m-diisopropylbenzene (bisphenol M), 9,9-bis(4-hydroxy-3-methylphenyl)fluorene, 1,1-bis(4-hydroxyphenyl)cyclohexane, 1,1-bis(4-hydroxyphenyl)-3,3,5-trimethylcyclohexane, 4,4′-dihydroxy-3,3′-dimethyldiphenyl sulfide, bisphenol A, 2,2-bis(4-hydroxy-3-methylphenyl)propane (bisphenol C), 2,2-bis(4-hydroxyphenyl)-1,1,1,3,3,3-hexafluoropropane (bisphenol AF) and 1,1-bis(4-hydroxyphenyl)decane.

The copolycarbonate containing the unit (A) and the unit (B-1) is produced by reaction means known per se for producing an ordinary polycarbonate, for example, a method in which a diol component is reacted with a carbonate precursor such as diester carbonate. A brief description is subsequently given of basic means for these production methods.

A transesterification reaction using a diester carbonate as the carbonate precursor is carried out by stirring an aromatic dihydroxy component and the diester carbonate in a predetermined ratio under heating in an inert gas atmosphere and distilling off the formed alcohol or phenol. The reaction temperature which differs according to the boiling point of the formed alcohol or phenol is generally 120 to 300° C. The reaction is completed while the formed alcohol or phenol is distilled off by setting a reduced pressure from the beginning. An end sealing agent and an antioxidant may be added as required.

The diester carbonate used in the above transesterification reaction is an ester such as an aryl group or aralkyl group having 6 to 12 carbon atoms which may be substituted. Specific examples thereof include diphenyl carbonate, ditolyl carbonate, bis(chlorophenyl)carbonate and m-cresyl carbonate. Out of these, diphenyl carbonate is particularly preferred. The amount of diphenyl carbonate is preferably 0.97 to 1.10 moles, more preferably 1.00 to 1.06 moles based on 1 mole of the total of the dihydroxy compounds.

To increase the polymerization rate in the melt polymerization method, a polymerization catalyst may be used. The polymerization catalyst is selected from an alkali metal compound, an alkali earth metal compound, a nitrogen-containing compound and a metal compound.

As the above compounds, organic acid salts, inorganic salts, oxides, hydroxides, hydrides, alkoxides and quaternary ammonium hydroxides of an alkali metal or an alkali earth metal are preferably used. These compounds may be used alone or in combination.

Examples of the alkali metal compound include sodium hydroxide, potassium hydroxide, cesium hydroxide, lithium hydroxide, sodium hydrogen carbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenylphosphate, disodium salts, dipotassium salts, dicesium salts and dilithium salts of bisphenol A, and sodium salts, potassium salts, cesium salts and lithium salts of phenol.

Examples of the alkali earth metal compound include magnesium hydroxide, calcium hydroxide, strontium hydroxide, barium hydroxide, magnesium carbonate, calcium carbonate, strontium carbonate, barium carbonate, magnesium diacetate, calcium diacetate, strontium diacetate and barium diacetate.

Examples of the nitrogen-containing compound include quaternary ammonium hydroxides having an alkyl or aryl group such as tetramethylammonium hydroxide, tetraethylammonium hydroxide, tetrapropylammonium hydroxide, tetrabutylammonium hydroxide and trimethylbenzylammonium hydroxide. Tertiary amines such as triethylamine, dimethylbenzylamine and triphenylamine, and imidazoles such as 2-methylimidazole, 2-phenylimidazole and benzimidazole may be used. Bases and basic salts such as ammonia, tetramethylammonium borohydride, tetrabutylammonium borohydride, tetrabutylammonium tetraphenylborate and tetraphenylammonium tetraphenylborate may also be used.

Examples of the metal compound include zinc aluminum compounds, germanium compounds, organic tin compounds, antimony compounds, manganese compounds, titanium compounds and zirconium compounds. These compounds may be used alone or in combination of two or more.

The amount of the polymerization catalyst is preferably 1×10⁻⁹ to 1×10⁻² equivalent, more preferably 1×10⁻⁸ to 1×10⁻⁵ equivalent, much more preferably 1×10⁻⁷ to 1×10⁻³ equivalent based on 1 mole of the diol component.

A catalyst deactivator may be added in the latter stage of the reaction. Known catalyst deactivators are used effectively as the catalyst deactivator. Out of these, ammonium salts and phosphonium salts of sulfonic acid are preferred. Salts of dodecylbenzenesulfonic acid such as tetrabutylphosphonium salts of dodecylbenzenesulfonic acid and salts of paratoluenesulfonic acid such as tetrabutylammonium salts of paratoluenesulfonic acid are more preferred.

As the ester of sulfonic acid, methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate and phenyl paratoluenesulfonate are preferably used. Out of these, tetrabutylphosphonium salts of dodecylbenzenesulfonic acid are most preferably used.

When at least one polymerization catalyst selected from alkali metal compounds and/or alkali earth metal compounds is used, the amount of the catalyst deactivator is preferably 0.5 to 50 moles, more preferably 0.5 to 10 moles, much more preferably 0.8 to 5 moles based on 1 mole of the polymerization catalyst.

### (Copolycarbonate (2))

Another preferred example of the polycarbonate used in the present invention is a copolycarbonate (2) which contains the unit (A) and a carbonate unit (B-2) derived from at least one compound selected from the group consisting of an aliphatic diol compound and an alicyclic diol compound and has (i) a blocking property, (ii) a total content of the unit (A) and the unit (B-2) of 80 mol % or more based on the total of all the recurring units and (iii) a (A/(B-2)) molar ratio of the unit (A) to the unit (B-2) of 60/40 to 95/5.

The copolycarbonate (2) has a block structure in the unit (B-2).

The total content of the unit (A) and the unit (B-2) is preferably 90 mol % or more, more preferably 95 mol % or more, much more preferably 100 mol % based on the total of all the recurring units.

The (A/(B-2)) molar ratio of the unit (A) to the unit (B-2) is preferably 65/35 to 93/7, more preferably 70/30 to 90/10. Within the above range, balance among heat resistance, weather resistance, low water absorption, surface hardness and low-temperature impact properties becomes excellent advantageously. The (A/(B-2)) molar ratio can be calculated by measurement with the proton NMR of JNM-AL400 of JEOL Ltd.

An aliphatic diol compound constitutes the unit (B-2). The aliphatic diol compound may be either a linear aliphatic diol compound or a branched aliphatic diol compound.

As the linear aliphatic diol compound, a linear aliphatic diol compound having preferably 2 to 30 carbon atoms, more preferably 3 to 20 carbon atoms, much more preferably 3 to 10 carbon atoms is used. Examples of the linear aliphatic diol compound include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, hydrogenated dilinoleyl glycol and hydrogenated dioleyl glycol. Out of these, 1,3-propanediol, 1,4-butanediol, 1,6-hexanediol and 1,10-decanediol are preferred.

As the branched aliphatic diol compound, a branched aliphatic diol compound having preferably 3 to 30 carbon atoms, more preferably 3 to 20 carbon atoms, much more preferably 4 to 12 carbon atoms is used. Examples of the branched aliphatic diol compound include 1,3-butylene glycol, 2-methyl-1,3-propanediol, neopentyl glycol, 2-ethyl-1,6-hexanediol, 2,2,4-trimethyl-1,6-hexanediol, 3-methyl-1,5-pentanediol, 2-n-butyl-2-ethyl-1,3-propanediol, 2,2-diethyl-1,3-propanediol, 2,4-diethyl-1,5-pentanediol, 1,2-hexane glycol, 1,2-octyl glycol, 2-ethyl-1,3-hexanediol, 2,3-diisobutyl-1,3-propanediol, 2,2-diisoamyl-1,3-propanediol and 2-methyl-2-propyl-1,3-propanediol. Out of these, 3-methyl-1,5-pentanediol, 2-n-butyl-2-ethyl-1,3-propanediol, 2,2-diethyl-1,3-propanediol and 2,4-diethyl-1,5-pentanediol are preferred.

An alicyclic diol compound constitutes the unit (B-2) As the alicyclic diol compound, an alicyclic diol compound having preferably 6 to 30 carbon atoms, more preferably 6 to 20 carbon atoms is used. Examples of the alicyclic diol compound include cyclohexanediols such as 1,2-cyclohexanediol, 1,3-cyclohexanediol, 1,4-cyclohexanediol and 2-methyl-1,4-cyclohexanediol; cyclohexanedimethanols such as 1,2-cyclohexanedimethanol, 1,3-cyclohexanedimethanol and 1,4-cyclohexanedimethanol; norbornanedimethanols such as 2,3-norbornanedimethanol and 2,5-norbornanedimethanol; and tricyclodecanedimethanol, pentacyclopentadecanedimethanol, 1,3-adamantanediol, 2,2-adamantanediol, decalindimethanol, 2,2,4,4-tetramethyl-1,3-cyclobutanediol and 3,9-bis(2-hydroxy-1,1-dimethylethyl)-2,4,8,10-tetraoxaspiro[5.5]undecane. Out of these, 1,4-cyclohexanedimethanol, tricyclodecanedimethanol and 3,9-bis(2-hydroxy-1,1-dimethylethyl)-2,4,8,10-tetraoxaspiro[5.5]undecane are preferred. These aliphatic diol compounds and alicyclic diol compounds may be used alone or in combination of two or more.

### (Blocking Property)

The copolycarbonate (2) has a block unit (B-2). The average number (n) of the recurring units (B-2) in the block part is preferably 2 to 100, more preferably 2.2 to 50, much more preferably 2.3 to 30, particularly preferably 2.5 to 10. The number average molecular weight of the unit (B-2) in the block part is preferably 250 to 5,000, more preferably 300 to 3,000, much more preferably 300 to 2,000, particularly preferably 350 to 1,500. When the average number (n) of the recurring units (B-2) and the number average molecular weight of the unit (B-2) in the block part fall within the above ranges, targeted water absorption and heat resistance as well as pencil hardness become excellent and phase separation hardly occur advantageously.

The blocking property of the unit (B-2) in the copolycarbonate (2) can be calculated from the carbon of a carbonate measured with ¹³C-NMR by dissolving the copolycarbonate (2) in CDCl₃. In general, there are three signals for [unit (A)-unit (A)] at 153 to 154 ppm (because there are three stereoisomers), there are two signals for [unit (A)-unit (B-2)] at 154 to 155 ppm (when there is no stereoisomer of a copolymerization diol, there are two stereoisomers to isosorbide), and a signal for [unit (B-2)-unit (B-2)] is generally measured at 155 to 156 ppm. The average number of the recurring units (B-2) can be calculated from the integrated value of these signals. The average number of the recurring units (B-2) is obtained from the following equation. The number average molecular weight of the unit (B-2) in the block part is calculated by multiplying the average number of the recurring units by the molecular weight of the recurring unit.

Average number of recurring units (B-2)=integrated value of signals for [unit (B-2)−unit (B-2)]/integrated value of signals for [unit (A)−unit (B-2)])×2+1

### (Unit (B-2a))

The unit (B-2) is preferably a unit (B-2a) represented by the following formula.

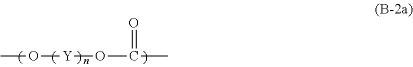

Y in the unit (B-2a) is an alkylene group having preferably 2 to 30 carbon atoms, more preferably 3 to 20 carbon atoms, much more preferably 3 to 10 carbon atoms. Examples of the alkylene group having 2 to 12 carbon atoms include ethylene group, trimethylene group, tetramethylene group, pentylene group, hexylene group, octylene group, nonylene group, decylene group and dodecylene group.

Y in the unit (B-2a) is a cycloalkylene group having preferably 6 to 30 carbon atoms, more preferably 6 to 20 carbon atoms. Examples of the cycloalkylene group having 6 to 30 carbon atoms include cyclohexylene group, cyclooctylene group, cyclononylene group, cyclodecylene group and cyclododecylene group.

“n” indicative of the size of the block of the unit —(Y)ₙ— is preferably 2 to 100, more preferably 2.2 to 50, much more preferably 2.3 to 30, particularly preferably 2.5 to 10. The number average molecular weight of the unit (B-2a) is preferably 250 to 5,000, more preferably 300 to 3,000, much more preferably 300 to 2,000, particularly preferably 350 to 1,500.

A compound inducing a unit except for the unit (A) and the unit (B-2), such as an oxyalkylene glycol or an aromatic dihydroxy compound, may be used as well.

### (Production of Copolycarbonate (2))

The copolycarbonate (2) is preferably produced by obtaining a polycarbonate oligomer represented by the recurring unit (B-2) from at least one compound selected from the group consisting of an aliphatic diol compound and an alicyclic diol compound and reacting the obtained polycarbonate oligomer with a monomer inducing the unit (A) (for example, isosorbide) and a carbonate precursor.

### (i) Production Method of Polycarbonate Oligomer

The polycarbonate oligomer is produced by reaction means known per se for producing an ordinary polycarbonate, for example, a method in which a diol compound is reacted with a carbonate precursor such as diester carbonate, or a known method for producing a polycarbonate diol. A brief description is subsequently given of basic means for these production methods.

A transesterification reaction using a diester carbonate as the carbonate precursor is carried out by stirring a diol component and the diester carbonate in a predetermined ratio under heating in an inert gas atmosphere and distilling off the formed alcohol or phenol. The reaction temperature which differs according to the boiling point of the formed alcohol or phenol is generally 120 to 300° C. The reaction is carried out while the formed alcohol or phenol is distilled off by setting a reduced pressure from the beginning. An antioxidant may be added as required.

As the diester carbonate used in the above transesterification reaction, the same diester carbonate as the above diester carbonate may be used.

As the catalyst which can be used, the same catalyst as the above catalyst (transesterification catalyst) may be used.

The production method of the polycarbonate oligomer may be carried out in the presence or absence of a catalyst, preferably in the presence of a catalyst from the viewpoint of reaction efficiency.

The reaction temperature in the production method of the polycarbonate oligomer is preferably 90 to 230° C., more preferably 100 to 220° C., much more preferably 120 to 210° C. When the reaction temperature is higher than 230° C., the obtained polycarbonate oligomer may be colored, or an ether structure may be formed.

Since the amount of the by-produced alcohol or phenol is relatively small in the initial stage of the reaction in the production method of the polycarbonate oligomer, the transesterification reaction is carried out at 10 kPa to normal pressure to suppress the distillation of the diester carbonate. In the closing stage of the transesterification reaction, for example, after the transesterification reaction proceeds preferably 50% or more, more preferably 70% or more, the transesterification reaction is desirably carried out under a reduced pressure of preferably 0.1 to 10 kPa, more preferably 0.1 to 1 kPa.

The number average molecular weight of the polycarbonate oligomer is preferably 250 to 5,000, more preferably 300 to 3,000, much more preferably 400 to 2,000, particularly preferably 400 to 1,500. When the number average molecular weight is lower than 250, targeted water absorption and heat resistance and pencil hardness may degrade. When the number average molecular weight is higher than 5,000, the blocking property becomes too high, whereby phase separation tends to occur. The number average molecular weight of the polycarbonate oligomer can be calculated by measuring proton NMR. The terminal hydroxyl group and the terminal phenyl group are calculated based on the recurring unit by proton NMR to calculate the number average molecular weight from the following equation.

Number average molecular weight of polycarbonate oligomer=(integrated value of signals of recurring unit)/(integrated value of signals of terminal hydroxyl group+integrated value of signals of terminal phenyl group)×2×molecular weight of recurring unit

The ratio of the terminal hydroxyl group and the terminal phenyl group of the polycarbonate oligomer is not particularly limited and may be arbitrary.

The production of the polycarbonate oligomer may be carried out in the same reaction vessel as that for the production of the copolycarbonate or a different reaction vessel. The polycarbonate oligomer may be taken out from the reaction vessel and kept before use. The polycarbonate oligomer may be refined by using a filter or reprecipitation.

### (ii) Production of Copolycarbonate (2)

The copolycarbonate (2) is produced by reacting the polycarbonate oligomer obtained by the above method, a monomer inducing the unit (A) (for example, isosorbide) and a carbonate precursor by reaction means known per se for producing an ordinary polycarbonate. A brief description is subsequently given of basic means for these production methods.

A transesterification reaction using a diester carbonate as the carbonate precursor is carried out by stirring a diol component and the diester carbonate in a predetermined ratio under heating in an inert gas atmosphere and distilling off the formed alcohol or phenol. The reaction temperature which differs according to the boiling point of the formed alcohol or phenol is generally 120 to 300° C. The reaction is completed while the formed alcohol or phenol is distilled off by setting a reduced pressure from the beginning. An end sealing agent and an antioxidant may be added as required.

The diester carbonate used in the above transesterification reaction is the same as the above diester carbonate. Diphenyl carbonate is particularly preferred.

The amount of diphenyl carbonate is preferably 0.97 to 1.10 moles, more preferably 1.00 to 1.06 moles based on 1 mole of the total of the dihydroxy compounds.

To increase the polymerization rate in the melt polymerization method, a polymerization catalyst may be used. As the polymerization catalyst, the same catalyst as the above catalyst (transesterification catalyst) may be used.

The amount of the polymerization catalyst is preferably 1×10⁻⁹ to 1×10⁻² equivalent, more preferably 1×10⁻⁸ to 1×10⁻⁵ equivalent, much more preferably 1×10⁻⁷ to 1×10⁻³ equivalent based on 1 mole of the diol component.

A catalyst deactivator may be added in the latter stage of the reaction. As the catalyst deactivator in use, the above catalyst deactivator may be used.

As for the amount of the polymerization deactivator, when at least one polymerization catalyst selected from alkali metal compounds and/or alkali earth metal compounds is used, the polymerization deactivator is used in an amount of preferably 0.5 to 50 moles, more preferably 0.5 to 10 moles, much more preferably 0.8 to 5 moles based on 1 mole of the catalyst.

### (Copolycarbonate (3))

Still another preferred example of the polycarbonate used in the present invention is a copolycarbonate (3) which contains the unit (A) and a unit (B-3) represented by the following formula and has (i) a total content of the unit (A) and the unit (B-3) of 80 mol % or more based on the total of all the recurring units and (ii) a (A/(B-3)) molar ratio of the unit (A) to the unit (B-3) of 50/50 to 95/5.

The copolycarbonate (3) has a structure with a side chain.

The total content of the unit (A) and the unit (B-3) is preferably 90 mol % or more, more preferably 95 mol % or more, much more preferably 100 mol % based on the total of all the recurring units.

The (A/(B-3)) molar ratio of the unit (A) to the unit (B-3) is preferably 60/40 to 95/5, more preferably 60/40 to 93/7, much more preferably 70/30 to 90/10. Within the above range, balance among heat resistance, weather resistance, low water absorption, surface hardness and low-temperature impact properties becomes excellent advantageously. The (A/(B-3)) molar ratio can be calculated by measurement with the proton NMR of JNM-AL400 of JEOL Ltd.

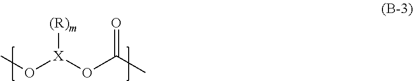

In the above formula, X is an alkylene group having 3 to 20 carbon atoms or cycloalkylene group having 3 to 20 carbon atoms, R is an alkyl group having 1 to 20 carbon atoms or cycloalkyl group having 3 to 20 carbon atoms, and “m” is an integer of 1 to 10.

The unit (B-3) is a unit derived from an aliphatic diol having a side-chain alkyl group or a side-chain cycloalkyl group.

The total number of carbon atoms of the unit (B-3) is preferably 4 to 12, more preferably 5 to 10. Within this range, HDT (deflection temperature under load) of the polycarbonate is kept high.

The total number of carbon atoms of X (number of main-chain carbon atoms) and carbon atoms of R (number of side-chain carbon atoms) of the unit (B-3) satisfies preferably the following equation (i), more preferably the following equation (i-a), much more preferably the following equation (i-b).

When the following equation (i) is satisfied, boiling water resistance becomes excellent and water absorption coefficient can be significantly reduced advantageously.

0.3≦(number of main-chain carbon atoms)/(number of side-chain carbon atoms)≦8 (i)

0.4≦(number of main-chain carbon atoms)/(number of side-chain carbon atoms)≦5 (i-a)

0.5≦(number of main-chain carbon atoms)/(number of side-chain carbon atoms)≦2 (i-b)

### (X in Unit (B-3))

In the formula (B-3), X is an alkylene group having 3 to 20 carbon atoms or cycloalkylene group having 3 to 20 carbon atoms.

X is an alkylene group having preferably 3 to 12 carbon atoms, more preferably 3 to 8 carbon atoms, much more preferably 2 to 6 carbon atoms. Examples of the alkylene group include propylene group, butylene group, pentylene group, hexylene group, heptylene group and octylene group.

X is a cycloalkylene group having preferably 3 to 12 carbon atoms, more preferably 3 to 8 carbon atoms, much more preferably 3 to 6 carbon atoms. Examples of the cycloalkylene group include cyclopropylene group, cyclobutylene group, cyclopentylene group, cyclohexylene group, cycloheptylene group and cyclooctylene group.

### (R in Unit (B-3))

In the formula (B-3), R is an alkyl group having 1 to 20 carbon atoms or cycloalkyl group having 3 to 20 carbon atoms.

R is an alkyl group having preferably 1 to 12 carbon atoms, more preferably 1 to 8 carbon atoms. Examples of the alkyl group include methyl group, ethyl group, propyl group, butyl group, pentyl group, hexyl group, heptyl group and octyl group.

R is a cycloalkyl group having preferably 3 to 12 carbon atoms, more preferably 3 to 8 carbon atoms. Examples of the cycloalkyl group include cyclopropyl group, cyclobutyl group, cyclopentyl group, cyclohexyl group, cycloheptyl group and cyclooctyl group.

(“m” in Unit (B))

In the formula (B), “m” is an integer of 1 to 10, preferably 2 to 8, more preferably 2 to 5.

### (When X in Unit (B) is an Alkylene Group Having 3 to 20 Carbon Atoms)

Preferably, in the unit (B), X is an alkylene group having 3 to 20 carbon atoms, R is an alkyl group having 1 to 4 carbon atoms, and “m” is an integer of 2 to 8. More preferably, in the unit (B), X is an alkylene group having 3 to 5 carbon atoms, R is an alkyl group having 1 to 4 carbon atoms, and “m” is an integer of 1 to 2.

—X—{—(R)ₘ}— in the unit (B-3) is preferably a unit (Ba) represented by the following formula.

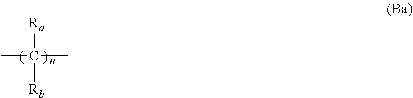

“n” is an integer of 2 to 6, preferably 3 to 5. An “n” number of Rₐ's are each independently selected from hydrogen atom and alkyl group having 1 to 4 carbon atoms. An “n” number of R_{b}'s are each independently selected from hydrogen atom and alkyl group having 1 to 4 carbon atoms. Preferably, one or two of an “n” number of Rₐ's and an “n” number of R_{b}'s are alkyl groups having 1 to 4 carbon atoms, and the other are hydrogen atoms.

—X{—(R)ₘ}— in the unit (B-3) is preferably a 2-n-butyl-2-ethyl-1,3-propanediyl group, 2,4-diethyl-1,5-pentanediyl group or 3-methyl-1,5-pentanediyl group.

### (When X in Unit (B-3) is a Cycloalkylene Group Having 3 to 20 Carbon Atoms)

Preferably, in the above formula (B-3), X is a cycloalkylene group having 4 to 5 carbon atoms, R is an alkyl group having 1 to 10 carbon atoms, and “m” is an integer of 3 to 12.

The unit (B-3) is preferably a unit (Bb) represented by the following formula.

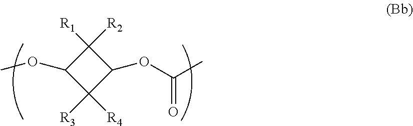

R₁, R₂, R₃ and R₄ are alkyl groups which may be the same or different, the total number of carbon atoms of R₁ to R₄ is 4 to 10, and R₁ and R₂, and R₃ and R₄ may be bonded together to form a carbon ring. Preferably, R₁, R₂, R₃ and R₄ in the unit (Bb) are each independently a methyl group, ethyl group or propyl group.

The unit (B-3) is preferably a unit (Bb-i) represented by the following formula.

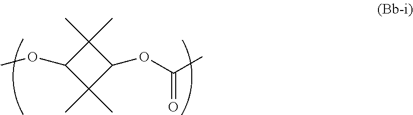

The unit (B-3) is derived from an aliphatic diol having a side-chain alkyl group or a side-chain cycloalkyl group.

Examples of the aliphatic diol having a side-chain alkyl group or a side-chain cycloalkyl group include 1,3-butylene glycol, 2-methyl-1,3-propanediol, neopentyl glycol, 3-methyl-1,5-pentanediol, 2-n-butyl-2-ethyl-1,3-propanediol, 2,2-diethyl-1,3-propanediol, 2,4-diethyl-1,5-pentanediol, 1,2-hexane glycol, 1,2-octyl glycol, 2-ethyl-1,3-hexanediol, 2,3-diisobutyl-1,3-propanediol, 1,12-octadecanediol, 2,2-diisoamyl-1,3-propanediol, 2-methyl-2-propyl-1,3-propanediol, 2-cyclohexyl-1,3-propanediol, 2-methyl-1,4-cyclohexanedimethanol and 2,2,4,4-tetramethyl-1,3-cyclobutanediol.

Out of these, 3-methyl-1,5-pentanediol, 2-n-butyl-2-ethyl-1,3-propanediol, 2,2-diethyl-1,3-propanediol and 2,4-diethyl-1,5-pentanediol are preferred, and 2-n-butyl-2-ethyl-1,3-propanediol and 2,4-diethyl-1,5-pentanediol are particularly preferred. They may be used in combination of two or more.

A diol compound inducing a unit except for the unit (A) and the unit (B-3) may be any one of the above monomer compounds inducing the unit (B-1) and the unit (B-2), and aliphatic diol compounds, alicyclic diol compounds and aromatic dihydroxy compounds except for these monomer compounds. Examples thereof include diol compounds and oxyalkylene glycols such as diethylene glycol, triethylene glycol, tetraethylene glycol and polyethylene glycol described in the pamphlet of WO2004/111106 and the pamphlet of WO2011/021720.

The aliphatic dihydroxy compounds, the alicyclic dihydroxy compounds and the aromatic dihydroxy compounds are the same as those enumerated above.

The copolycarbonate containing the unit (A) and the unit (B-3) is produced by reaction means known per se for producing an ordinary polycarbonate, for example, a method in which a diol component is reacted with a carbonate precursor such as diester carbonate. The basic means for these production methods is the same as the means of the above copolycarbonate containing the unit (A) and the unit (B-1).

### (Copolycarbonate (4))

A further example of the polycarbonate used in the present invention is a copolycarbonate (4) which contains the unit (A) and a carbonate unit (B-4) derived from a polyester diol and has (i) a total content of the unit (A) and the unit (B-4) of 80 mol % or more based on the total of all the recurring units and (ii) a (A/(B-4)) molar ratio of the unit (A) to the unit (B-4) of 50/50 to 99/1.

The total content of the unit (A) and the unit (B-4) is preferably 90 mol % or more, more preferably 95 mol % or more, much more preferably 100 mol % based on the total of all the recurring units.

The (A/(B-4)) molar ratio of the unit (A) to the unit (B-4) is preferably 60/40 to 95/5, more preferably 70/30 to 98/2, much more preferably 90/10 to 97.5/2.5. Within the above range, balance among heat resistance, weather resistance, low water absorption, surface hardness and low-temperature impact properties becomes excellent advantageously. The (A/(B-4)) molar ratio can be calculated by measurement with the proton NMR of JNM-AL400 of JEOL Ltd.

The unit (B-4) is a carbonate unit derived from a polyester diol containing a dicarboxylic acid component and a diol component as constituent components.

The preferred dicarboxylic acid is an aliphatic carboxylic acid, aromatic carboxylic acid or aromatic aliphatic carboxylic acid having 4 to 20 carbon atoms. It is preferably at least one dicarboxylic acid selected from the group consisting of 2,2-dimethylmalonic acid, succinic acid, glutaric acid, adipic acid, pimelic acid, sebacic acid, suberic acid, azelaic acid, 1,4-cyclohexanedicarboxylic acid, orthophthalic acid, phthalic anhydride, naphthalic acid, biphenyldicarboxylic acid, hexahydrophthalic acid, 5-methylisophthalic acid, terephthalic acid and isophthalic acid. It is particularly preferably at least one dicarboxylic acid selected from the group consisting of adipic acid, sebacic acid, 1,4-cyclohexanedicarboxylic acid, terephthalic acid and isophthalic acid. These dicarboxylic acid components may be used alone or in combination of two or more.

The preferred diol component is selected from a linear aliphatic diol compound, a branched aliphatic diol compound and an alicyclic diol compound.

Examples of the linear aliphatic diol compound include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, hydrogenated dilinoleyl glycol and hydrogenated dioleyl glycol. Out of these, 1,3-propanediol, 1,4-butanediol, 1,6-hexanediol and 1,10-decanediol are preferred.

Examples of the branched aliphatic diol compound include 1,3-butylene glycol, 2-methyl-1,3-propanediol, neopentyl glycol, 2-ethyl-1,6-hexanediol, 2,2,4-trimethyl-1,6-hexanediol, 3-methyl-1,5-pentanediol, 2-n-butyl-2-ethyl-1,3-propanediol, 2,2-diethyl-1,3-propanediol, 2,4-diethyl-1,5-pentanediol, 1,2-hexane glycol, 1,2-octyl glycol, 2-ethyl-1,3-hexanediol, 2,3-diisobutyl-1,3-propanediol, 2,2-diisoamyl-1,3-propanediol, 2-methyl-2-propyl-1,3-propanediol, glycerin, trimethylolpropane and pentaerythritol. Out of these, 3-methyl-1,5-pentanediol, 2-n-butyl-2-ethyl-1,3-propanediol, 2,2-diethyl-1,3-propanediol and 2,4-diethyl-1,5-pentanediol are preferred.

Examples of the alicyclic diol compound include cyclohexanediols such as 1,2-cyclohexanediol, 1,3-cyclohexanediol, 1,4-cyclohexanediol and 2-methyl-1,4-cyclohexanediol; cyclohexanedimethanols such as 1,2-cyclohexanedimethanol, 1,3-cyclohexanedimethanol and 1,4-cyclohexanedimethanol; norbornanedimethanols such as 2,3-norbornanedimethanol and 2,5-norbornanedimethanol; and tricyclodecanedimethanol, pentacyclopentadecanedimethanol, 1,3-adamantanediol, 2,2-adamantanediol, decalindimethanol, 2,2,4,4-tetramethyl-1,3-cyclobutanediol and 3,9-bis(2-hydroxy-1,1-dimethylethyl)-2,4,8,10-tetraoxaspiro[5.5]undecane. Out of these, 1,4-cyclohexanedimethanol, tricyclodecanedimethanol and 3,9-bis(2-hydroxy-1,1-dimethylethyl)-2,4,8,10-tetraoxaspiro[5.5]undecane are preferred.

These diol compounds may be used alone or in combination of two or more.

The preferred polyester diol (B4) is represented by the following formula.

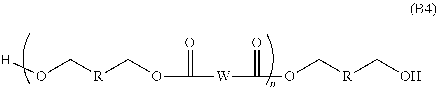

In the above formula, R is a hydrocarbon group which may contain an aromatic group having 1 to 12 carbon atoms, specifically, an aliphatic or alicyclic moiety of the above linear aliphatic diol compound, branched aliphatic diol compound or alicyclic diol compound.

W is a hydrocarbon group which may contain an aromatic group having 1 to 12 carbon atoms, specifically, an aliphatic, aromatic or aromatic aliphatic moiety of the above aliphatic carboxylic acid, aromatic carboxylic acid or aromatic aliphatic carboxylic acid.

“n” is the average number of recurring units. As will be described hereinafter, the weight average molecular weight of the polyester diol (B1) is preferably 100 to 3,000, and it is preferred to set the average number “n” of the recurring units so as to obtain this weight average molecular weight.

The polyester diol may be produced by a known polyester diol production process.

A metal-based catalyst used in the polyester diol production process is selected from Lewis acid, a carboxylate salt of an alkali metal or an alkali earth metal, protonic acid, activated white clay, acid white clay and ion exchange resin. Specific examples thereof include tetrabutoxy titanate, dibutyltin oxide, manganese acetate, cobalt acetate, zinc acetate, zinc benzoate, lithium acetate, sodium acetate, magnesium acetate, calcium acetate, antimony oxide, germanium oxide, phosphoric acid, boric acid, sulfuric acid, p-toluenesulfonic acid, metasulfonic acid and Amberlyst E15. The amount of the catalyst is 10 to 5,000 μg, preferably 50 to 1,000 g based on the raw material polyalkylene terephthalate.

The reaction temperature for carrying out a transesterification reaction in the polyester diol production process is generally 150 to 300° C., preferably 200 to 250° C. The pressure is not limited but generally normal pressure to 1 MPa. The reaction time of the transesterification reaction is not particularly limited but generally 0.5 to 5 hours. The transesterification reaction may be carried out in a batch, semi-batch or continuous manner.

A glycol component by-produced by the transesterification reaction is distilled off as required. Thereby, the hydroxyl number and viscosity of the polyester diol can be controlled to predetermined ranges. Although there are no limiting conditions for distilling off the glycol component, the glycol component is generally distilled off under heating and reduced pressure. Although the glycol component may be distilled off while the reaction is carried out in the presence of a transesterification reaction catalyst or after the end of the reaction, it is preferred that the glycol component should be distilled off during the reaction because it is possible to control the ratio of the acid component and the glycol component during the reaction. The temperature for distilling off the glycol is generally 150 to 300° C., preferably 200 to 250° C. The pressure is generally 0.5 to 0.0001 MPa, preferably 0.1 to 0.001 MPa.

Impurities such as metals may be removed from the obtained polyester diol. It is preferred to remove metals, especially antimony and germanium, by using an adsorbent. Further, since hydrolyzability and thermal stability deteriorate when the catalyst used for transesterification remains in the diol, the catalyst may be removed by using an adsorbent. A catalyst which is hydrolyzed by water to become a compound insoluble in a diol, such as tetrabutoxy titanate, may be removed by adding water to hydrolyze it so as to precipitate it and separating it by filtration.

The weight average molecular weight of the polyester diol is not particularly limited but preferably 100 to 3,000, more preferably 200 to 2,500, much more preferably 300 to 2,000, particularly preferably 400 to 1,500, most preferably 450 to 1,000. When the weight average molecular weight of the polyester diol is lower than 100, the acid value tends to become large, thereby affecting a polymerization reaction and reducing productivity. When the weight average molecular weight of the polyester diol is higher than 3,000, phase separation tends to occur.

The acid value of the polyester diol is preferably 1 mgKOH/g or less, more preferably 0.3 mgKOH/g or less. When the acid value is larger than 1 mgKOH/g, the polyester diol may affect a polymerization reaction, thereby reducing productivity.

The polyester carbonate resin is produced by reacting the polyester diol obtained by the above method, a monomer inducing the unit (A) (such as isosorbide) and a carbonate precursor by reaction means known per se for producing an ordinary polycarbonate. The basic means for these production methods is the same as the means for the above copolycarbonate containing the unit (A) and the unit (B-1).

### (Low-Temperature Surface Impact)

The polycarbonate has predetermined values of (i) maximum impact energy and (ii) brittle fracture rate in a high-speed surface impact test based on ASTM D3763 in a −20° C. environment.

The high-speed surface impact test based on ASTM D3763 is carried out at a testing temperature of −20° C., a testing speed of 7 m/sec, a striker diameter of ½ inch and a receptor diameter of 1 inch by using a 2 mm-thick rectangular plate and a high-speed impact tester.

(i) The polycarbonate has a maximum impact energy of 20 J or more, preferably 25 J or more, more preferably 30 J or more, particularly preferably 35 J or more. Although the upper limit value is not particularly limited, a maximum impact energy of 100 J or less suffices.
(ii) The polycarbonate has a brittle fracture rate of 50% or less, preferably 40% or less, more preferably 30% or less, much more preferably 20% or less, particularly preferably 15% or less, most preferably 10% or less.

The fracture morphology of low-temperature surface impact of the polycarbonate becomes ductile fracture, which means that the polycarbonate is excellent in low-temperature impact properties. When the probability that the fracture morphology of low-temperature surface impact becomes brittle fracture is more than 50% or when the maximum impact energy is less than 20 J, it is difficult to use the polycarbonate in cold districts.

(Specific Viscosity: ηₛₚ)

The specific viscosity (ηₛₚ) of the polycarbonate is preferably 0.23 to 0.60, more preferably 0.25 to 0.55, much more preferably 0.30 to 0.50, particularly preferably 0.35 to 0.45. When the specific viscosity is 0.23 or more, the strength of a molded piece formed by injection molding becomes satisfactory and when the specific viscosity is 0.60 or less, injection moldability becomes high advantageously.

The specific viscosity is obtained from a solution prepared by dissolving 0.7 g of the polycarbonate in 100 ml of methylene chloride at 20° C. by using an Ostwald viscometer.

Specific viscosity (ηₛₚ)=(t−t₀)/t₀

[“t₀” is the number of seconds required for the dropping of methylene chloride, and “t” is the number of seconds required for the dropping of a sample solution]

The measurement of the specific viscosity may be carried out, for example, by the following procedure. The polycarbonate is first dissolved in methylene chloride in an amount which is 20 to 30 times the weight of the polycarbonate, soluble matter is collected by cerite filtration, the solution is removed, and the residue is fully dried to obtain a methylene chloride-soluble solid. The specific viscosity at 20° C. is obtained from a solution prepared by dissolving 0.7 g of the solid in 100 ml of methylene chloride by using an Ostwald viscometer.

### (Impurities)

The content of the monohydroxy compound in the polycarbonate is preferably 700 ppm or less, more preferably 500 ppm or less, particularly preferably 200 ppm or less in a reaction solution at the outlet of a final polymerization reactor. The concentration of the diester carbonate in the polycarbonate of the present invention is preferably 200 ppm or less by weight, more preferably 100 ppm or less by weight, particularly preferably 60 ppm or less by weight, most preferably 30 ppm or less by weight. The contents of these impurities can be reduced by controlling the vacuum degree of the polymerization reaction.

### (Glass Transition Temperature: Tg)

The glass transition temperature (Tg) of the polycarbonate is preferably 80 to 160° C., more preferably 90 to 150° C., much more preferably 100 to 140° C. When the glass transition temperature (Tg) is 80° C. or higher, the heat resistance of a molded article becomes satisfactory advantageously. When the glass transition temperature (Tg) is 160° C. or lower, injection moldability becomes high advantageously.

The glass transition temperature (Tg) is measured at a temperature elevation rate of 20° C./min by using the 2910 DSC of TA Instruments Japan.

### (Dynamic Viscoelasticity)

The polycarbonate has a temperature (Tₘₐₓ) at which tan δ of dynamic viscoelasticity measurement becomes maximum of preferably −73° C. or lower, more preferably −78° C. or lower, much more preferably −80° C. or lower.

### (Saturated Water Absorption Coefficient)

The saturated water absorption coefficient of the polycarbonate is preferably 2.5% or less, more preferably 2.2% or less, much more preferably 2.0% or less. When the saturated water absorption coefficient is 2.5% or less, the deterioration of various physical properties such as a dimensional change and warpage caused by water absorption rarely occurs in a molded article advantageously.

The relationship between the glass transition temperature (Tg° C.) and the water absorption coefficient (Wa %) of the polycarbonate satisfies preferably the following expression (I), more preferably the following expression (I-a). When the following expression (I) is satisfied, a polycarbonate having excellent heat resistance and a low water absorption coefficient is obtained advantageously. Although the upper limit of the TW value is not particularly limited, a TW value of 10 or less suffices.

2.5≦TW value=Tg×0.04−Wa (I)

2.6≦TW value=Tg×0.04−Wa (I-a)

### (Pencil Hardness)

The polycarbonate has a pencil hardness of preferably at least HB. The pencil hardness is preferably at least F, more preferably at least H as the polycarbonate is excellent in scratch resistance. The pencil hardness can be enhanced by increasing the contents of the recurring units (B-1) to (B-3) based on the total of all the recurring units. In the present invention, the term “pencil hardness” means such hardness that when the resin of the present invention is rubbed with a pencil having specific pencil hardness, no scratch mark is left, and pencil hardness used in the surface hardness test of a film which can be measured in accordance with JIS K-5600 is used as an index. The pencil hardness becomes lower in the order of 9H, 8H, 7H, 6H, 5H, 4H, 3H, 2H, H, F, HB, B, 2B, 3B, 4B, 5B and 6B, 9H is the hardest, and 6B is the softest.

### (Additives)

The polycarbonate may be mixed with additives such as a heat stabilizer, plasticizer, optical stabilizer, polymerization metal inactivating agent, flame retardant, lubricant, antistatic agent, surfactant, antibacterial agent, ultraviolet absorbent and release agent as required according to purpose.

The polycarbonate may be used in combination with another resin as long as the effect of the present invention is not impaired.

### (Heat Stabilizer)

The polycarbonate preferably contains a heat stabilizer in particular to suppress the reduction of molecular weight and the deterioration of color during extrusion/molding. Since the ether diol residue of the unit (A) tends to be deteriorated by heat and oxygen to be colored, a phosphorus-based stabilizer is preferably contained as the heat stabilizer. As the phosphorus-based stabilizer, a pentaerythritol type phosphite compound or a phosphite compound which reacts with a dihydric phenol and has a cyclic structure is preferably used.

Examples of the above pentaerythritol type phosphite compound include distearyl pentaerythritol diphosphite, bis(2,4-di-tert-butylphenyl)pentaerythritol diphosphite, bis(2,6-di-tert-butyl-4-methylphenyl)pentaerythritol diphosphite, bis(2,6-di-tert-butyl-4-ethylphenyl)pentaerythritol diphosphite, phenyl bisphenol A pentaerythritol diphosphite, bis(nonylphenyl)pentaerythritol diphosphite and dicyclohexyl pentaerythritol diphosphite. Out of these, distearyl pentaerythritol diphosphite and bis(2,4-di-tert-butylphenyl)pentaerythritol diphosphite are preferred.

Examples of the phosphite compound which reacts with a dihydric phenol and has a cyclic structure include 2,2′-methylenebis(4,6-di-tert-butylphenyl) (2,4-di-tert-butylphenyl)phosphite, 2,2′-methylenebis(4,6-di-tert-butylphenyl) (2-tert-butyl-4-methylphenyl)phosphite, 2,2′-methylenebis(4-methyl-6-tert-butylphenyl) (2-tert-butyl-4-methylphenyl)phosphite, 2,2′-ethylidenebis(4-methyl-6-tert-butylphenyl) (2-tert-butyl-4-methylphenyl)phosphite, 2,2′-methylenebis(4,6-di-t-butylphenyl)octyl phosphite and 6-tert-butyl-4-[3-[(2,4,8,10)-tetra-tert-butyldibenzo[d,f][1,3,2]dioxaphosphepin-6-yl]oxy]propyl]-2-methylphenol.

The other phosphorus-based stabilizers include phosphite compounds other than the above compounds, phosphonite compounds and phosphate compounds.

The phosphite compounds include triphenyl phosphite, tris(nonylphenyl)phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, 2,2-methylenebis(4,6-di-tert-butylphenyl)octyl phosphite, tris(diethylphenyl)phosphite, tris(di-iso-propylphenyl)phosphite, tris(di-n-butylphenyl)phosphite, tris(2,4-di-tort-butylphenyl)phosphite and tris(2,6-di-tert-butylphenyl)phosphite.

The phosphate compounds include tributyl phosphate, trimethyl phosphate, tricresyl phosphate, triphenyl phosphate, trichlorophenyl phosphate, triethyl phosphate, diphenylcresyl phosphate, diphenylmonoorthoxenyl phosphate, tributoxyethyl phosphate, dibutyl phosphate, dioctyl phosphate and diisopropyl phosphate. Triphenyl phosphate and trimethyl phosphate are preferred.

The phosphonite compounds include tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite, tetrakis(2,6-di-tert-butylphenyl)-3,3′-biphenylene diphosphonite, bis(2,4-di-tert-butylphenyl)-4-phenyl-phenyl phosphonite, bis(2,4-di-tert-butylphenyl)-3-phenyl-phenyl phosphonite, bis(2,6-di-n-butylphenyl)-3-phenyl-phenyl phosphonite, bis(2,6-di-tert-butylphenyl)-4-phenyl-phenyl phosphonite and bis(2,6-di-tert-butylphenyl)-3-phenyl-phenyl phosphonite. Tetrakis(di-tert-butylphenyl)-biphenylene diphosphonites and bis(di-tert-butylphenyl)-phenyl-phenyl phosphonites are preferred, and tetrakis(2,4-di-tert-butylphenyl)-biphenylene diphosphonites and bis(2,4-di-tert-butylphenyl)-phenyl-phenyl phosphonites are more preferred. The phosphonite compound may be and is preferably used in combination with the above phosphite compound having an aryl group substituted by two or more alkyl groups.

The phosphonate compounds include dimethyl benzene phosphonate, diethyl benzene phosphonate and dipropyl benzene phosphonate.

The above phosphorus-based heat stabilizers may be used alone or in combination of two or more.

The above phosphorus-based stabilizers may be used alone or in combination of two or more, and at least a pentaerythritol type phosphite compound or a phosphite compound having a cyclic structure is preferably used in an effective amount. The phosphorus-based stabilizer is used in an amount of preferably 0.001 to 1 part by weight, more preferably 0.01 to 0.5 part by weight, much more preferably 0.01 to 0.3 part by weight based on 100 parts by weight of the polycarbonate.

A hindered phenol-based heat stabilizer may be added as a heat stabilizer to the polycarbonate in combination with a phosphorus-based heat stabilizer so as to suppress the reduction of molecular weight and the deterioration of color during extrusion/molding.

The hindered phenol-based stabilizer is not particularly limited if it has an antioxidant function. Examples of the hindered phenol-based stabilizer include n-octadecyl-3-(4′-hydroxy-3′,5′-di-t-butylphenyl) propionate, tetrakis{methylene-3-(3′,5′-di-t-butyl-4-hydroxyphenyl) propionate}methane, distearyl(4-hydroxy-3-methyl-5-t-butylbenzyl)malonate, triethylene glycol-bis{3-(3-t-butyl-5-methyl-4-hydroxyphenyl) propionate}, 1,6-hexanediol-bis{3-(3,5-di-t-butyl-4-hydroxyphenyl) propionate}, pentaerythrityl-tetrakis{3-(3,5-di-t-butyl-4-hydroxyphenyl)propionate}, 2,2-thiodiethylenebis{3-(3,5-di-t-butyl-4-hydroxyphenyl) propionate}, 2,2-thiobis(4-methyl-6-t-butylphenol), 1,3,5-trimethyl-2,4,6-tris(3,5-di-t-butyl-4-hydroxybenzyl)benzene, tris(3,5-di-t-butyl-4-hydroxybenzyl)-isocyanurate, 2,4-bis{(octylthio)methyl}-o-cresol, isooctyl-3-(3,5-di-t-butyl-4-hydroxyphenyl)propionate, 2,5,7,8-tetramethyl-2(4′,8′,12′-trimethyltridecyl) chroman-6-ol and 3,3′,3′,5,5′,5″-hexa-t-butyl-a,a′,a″-(mesitylene-2,4, 6-triyl)tri-p-cresol.

Out of these, n-octadecyl-3-(4′-hydroxy-3′,5′-di-t-butylphenyl) propionate, pentaerythrityl-tetrakis{3-(3,5-di-t-butyl-4-hydroxyphenyl)propionate}, 3,3′,3″,5,5′,5″-hexa-t-butyl-a,a′,a″-(mesitylene-2,4, 6-triyl)tri-p-cresol and 2,2-thiodiethylenebis{3-(3,5-di-t-butyl-4-hydroxyphenyl) propionate} are preferred.

These hindered phenol-based stabilizers may be used alone or in combination of two or more.

The hindered phenol-based stabilizer is used in an amount of preferably 0.001 to 1 part by weight, more preferably 0.01 to 0.5 part by weight, much more preferably 0.01 to 0.3 part by weight based on 100 parts by weight of the polycarbonate.

### (Release Agent)

The polycarbonate may contain a release agent so as to further improve its releasability from a mold at the time of melt molding as long as the object of the present invention is not impaired.

The release agent is selected from a higher fatty acid ester of a monohydric or polyhydric alcohol, higher fatty acid, paraffin wax, beeswax, olefin-based wax, olefin-based wax containing a carboxyl group and/or a carboxylic anhydride group, silicone oil and organopolysiloxane.

The higher fatty acid ester is preferably a partial ester or full ester of a monohydric or polyhydric alcohol having 1 to 20 carbon atoms and a saturated fatty acid having 10 to 30 carbon atoms. Examples of the partial ester or full ester of a monohydric or polyhydric alcohol and a saturated fatty acid include monoglyceride stearate, diglyceride stearate, triglyceride stearate, monosorbitate stearate, stearyl stearate, monoglyceride behenate, behenyl behenate, pentaerythritol monostearate, pentaerythritol tetrastearate, pentaerythritol tetrapelargonate, propylene glycol monostearate, stearyl stearate, palmityl palmitate, butyl stearate, methyl laurate, isopropyl palmitate, biphenyl biphenate, sorbitan monostearate and 2-ethylhexyl stearate. Out of these, monoglyceride stearate, triglyceride stearate, pentaerythritol tetrastearate and behenyl behenate are preferably used.

The higher fatty acid is preferably a saturated fatty acid having 10 to 30 carbon atoms. Examples of the fatty acid include myristic acid, lauric acid, palmitic acid, stearic acid and behenic acid.

These release agents may be used alone or in combination of two or more. The amount of the release agent is preferably 0.01 to 5 parts by weight based on 100 parts by weight of the polycarbonate.

### (Ultraviolet Absorbent)

The polycarbonate may contain an ultraviolet absorbent. The ultraviolet absorbent is selected from a benzotriazole-based ultraviolet absorbent, benzophenone-based ultraviolet absorbent, triazine-based ultraviolet absorbent, cyclic imino-ester-based ultraviolet absorbent and cyanoacrylate-based ultraviolet absorbent, out of which a benzotriazole-based ultraviolet absorbent is preferred.

Examples of the benzotriazole-based ultraviolet absorbent include 2-(2′-hydroxy-5′-methylphenyl)benzotriazole, 2-(2′-hydroxy-5′-tert-butylphenyl)benzotriazole, 2-(2′-hydroxy-5′-tert-octylphenyl)benzotriazole, 2-(2′-hydroxy-3′,5′-di-tert-butylphenyl)benzotriazole, 2-(2′-hydroxy-3′,5′-di-tert-amylphenyl)benzotriazole, 2-(2′-hydroxy-3′-dodecyl-5′-methylphenyl)benzotriazole, 2-(2′-hydroxy-3′,5′-bis(α,α′-dimethylbenzyl)phenyl benzotriazole, 2-[2′-hydroxy-3′-(3″,4″,5″,6″-tetraphthalimidomethyl)-5′-methylphenyl]benzotriazole, 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2,2′-methylenebis[4-(1,1,3,3-tetramethylbutyl)-6-(2H-benzotriazol-2-yl)phenol] and condensate of methyl-3-[3-tert-butyl-5-(2H-benzotriazol-2-yl)-4-hydroxyphenylpropionate and polyethylene glycol.

The amount of the ultraviolet absorbent is preferably 0.01 to 2 parts by weight, more preferably 0.1 to 1 part by weight, much more preferably 0.2 to 0.5 part by weight based on 100 parts by weight of the polycarbonate.

### (Optical Stabilizer)

The polycarbonate may contain an optical stabilizer. When the polycarbonate contains an optical stabilizer, it is preferred in terms of weather resistance and a molded article thereof is hardly cracked.

Examples of the optical stabilizer include hindered amines such as 1,2,2,6,6-pentamethyl-4-piperidyl methacrylate, bis(2,2,6,6-tetramethyl-1-octyloxy-4-piperidinyl)didecanoate, bis(1,2,2,6,6-pentamethyl-4-piperidinyl)-[[3,5-bis(1,1-dimethylethyl)-4-hydroxyphenyl]methyl]butyl malonate, 2,4-bis[N-butyl-N-(1-cyclohexyloxy-2,2,6,6-tetramethylpiperidin-2-yl)amino]-6-(2-hydroxyethylamine)-1,3,5-triazine, bis(1,2,2,6,6-pentamethyl-4-piperidinyl)sebacate, methyl(1,2,2,6,6-pentamethyl-4-piperidnyl) sebacate, bis(2,2,6,6-tetramethyl-4-piperidyl)carbonate, bis(2,2,6,6-tetramethyl-4-piperidyl)succinate, bis(2,2,6,6-tetramethyl-4-piperidyl)sebacate, 4-benzoyloxy-2,2,6,6-tetramethylpiperidine, 4-octanoyloxy-2,2,6,6-tetramethylpiperidine, bis(2,2,6,6-tetramethyl-4-piperidyl)diphenylmethane-p,p′-dicarbamate, bis(2,2,6,6-tetramethyl-4-piperidyl)benzene-1,3-disulfonate and bis(2,2,6,6-tetramethyl-4-piperidyl)phenylphosphite, and nickel complexes such as nickel bis(octylphenyl sulfide, nickel complex-monoethylate 3,5-di-t-butyl-4-hydroxybenzyl phosphate and nickel dibutyl dithiocarbamate. These optical stabilizers may be used alone or in combination of two or more. The amount of the optical stabilizer is preferably 0.01 to 1 part by weight, more preferably 0.05 to 0.5 part by weight based on 100 parts by weight of the polycarbonate.

### (Bluing Agent)

The polycarbonate may contain a bluing agent to erase the yellow tint of a lens based on a polymer and an ultraviolet absorbent. A bluing agent which is generally used for polycarbonates may be used without any problem. In general, anthraquinone-based dyes are easily acquired and preferred.

Typical examples of the bluing agent include generic name Solvent Violet13 [CA. No (color index No) 60725], generic name Solvent Violet31 [CA. No 68210], generic name Solvent Violet33 [CA. No 60725], generic name Solvent Blue94 [CA. No 61500], generic name Solvent Violet36 [CA. No 68210], generic name Solvent Blue97 [Macrolex Violet RR] of Bayer AG] and generic name Solvent Blue45 [CA. No 61110].

These bluing agents may be used alone or in combination of two or more. The amount of the bluing agent is preferably 0.1×10⁻⁴ to 2×10⁻⁴ part by weight based on 100 parts by weight of the polycarbonate.

### (Production Method of Resin Composition)

A resin composition comprising the polycarbonate and the above-described additives can be produced, for example, by premixing components and optional components, melt kneading them together and pelletizing the kneaded product. Examples of the premixing means include a Nauter mixer, a twin-cylinder mixer, a Henschel mixer, a mechanochemical device and an extrusion mixer. During premixing, the resulting mixture may be granulated by means of an extrusion granulator or a briquetting machine. After premixing, the obtained mixture is melt kneaded by means of a melt kneader typified by a vented double-screw extruder and pelletized by means of a device such as a pelletizer. Other examples of the melt kneader include a Banbury mixer, a kneading roll and a constant heat stirring vessel, and a vented double-screw extruder is preferred. Alternatively, the components and the optional components may be supplied into a melt kneader typified by a double-screw extruder independently without being premixed together. The cylinder temperature at the time of melt kneading is preferably 180 to 270° C., more preferably 190 to 260° C., much more preferably 200 to 250° C. When the cylinder temperature is 270° C. or lower, the thermal decomposition of the polycarbonate rarely proceeds advantageously.

### <Resin Window>

The resin window of the present invention is molded from the above polycarbonate by an arbitrary method such as injection molding, compression molding or extrusion molding. Examples of the resin window include windows for airplanes, vehicles and automobiles, windows for sunroofs and construction machines, and windows for buildings, houses and greenhouses.

The resin window of the present invention may be subjected to various surface treatments. The surface treatments include hard coating, water-repellent or oil-repellent coating, hydrophilic coating, antistatic coating, ultraviolet absorption coating, infrared absorption coating and metallizing (deposition). Examples of the surface treating method include the coating of a liquid, vapor deposition, thermal spraying and plating. As the vapor deposition method, both physical vapor deposition and chemical vapor deposition may be used. Examples of the physical vapor deposition include vacuum vapor deposition, sputtering and ion plating. Examples of the chemical vapor deposition (CVD) include thermal CVD, plasma CVD and optical CVD.

Although the resin window of the present invention has satisfactory surface hardness, it becomes more suitable for use as a resin window by carrying out hard coating. That is, since a substrate molded article has satisfactory surface hardness, the characteristic properties of a hard coat layer can be developed more effectively.

Examples of the hard coating agent include silicone resin-based hard coating agents and organic resin-based hard coating agents. The silicone resin-based hard coating agents which form a cured resin layer having a siloxane bond include partially hydrolyzed condensates of a compound containing a compound equivalent to a trifunctional siloxane unit (such as a trialkoxysilane compound) as the main component, preferably partially hydrolyzed condensates containing a compound equivalent to a tetrafunctional siloxane unit (such as a tetraalkoxysilane compound) and partially hydrolyzed condensates obtained by filling metal oxide fine particles such as colloidal silica in these. The silicone resin-based hard coating agents may further contain a bifunctional siloxane unit and a monofunctional siloxane unit. Although the silicone resin-based hard coating agents contain an alcohol produced during a condensation reaction (in the case of partially hydrolyzed condensates of an alkoxysilane), they may be dissolved or dispersed in any organic solvent, water or a mixture thereof as required.

Examples of the organic solvent include lower fatty acid alcohols, polyhydric alcohols, and ethers and esters thereof. A surfactant such as a siloxane-based or alkyl fluoride-based surfactant may be added to the hard coat layer in order to obtain a smooth surface state.

The organic resin-based hard coating agents include melamine resin, urethane resin, alkyd resin, acrylic resin and polyfunctional acrylic resins. The polyfunctional acrylic resins include resins such as polyol acrylate, polyester acrylate, urethane acrylate, epoxy acrylate and phosphazene acrylate.

Out of these hard coating agents, silicone resin-based hard coating agents which have excellent long-term durability and relatively high surface hardness and ultraviolet curable acrylic resins or polyfunctional acrylic resins which provide a satisfactory hard coat layer relatively easily are preferred. The silicone resin-based hard coating agents are divided into a two-coat type consisting of a primer layer and a top layer and a one-coat type consisting of only one layer, all of which may be used.

Examples of the resin forming the primer layer (first layer) include urethane resin comprising a block isocyanate component and a polyol component, acrylic resin, polyester resin, epoxy resin, melamine resin, amino resin and polyfunctional acrylic resins such as polyester acrylate, urethane acrylate, epoxy acrylate, phosphazene acrylate, melamine acrylate and amino acrylate. They may be used alone or in combination of two or more. Out of these, a hard coating agent containing an acrylic resin or a polyfunctional acrylic resin in an amount of 50 wt %, preferably 60 wt % or more is preferred. A hard coating agent containing an acrylic resin or urethane acrylate is particularly preferred. After the resin is applied while it is unreacted, it may be subjected to a predetermined reaction to become a cured resin, or the reacted resin may be directly applied to form a cured resin layer. In the latter case, the resin is generally dissolved in a solvent to prepare a solution which is then applied and then the solvent is removed. In the former case, the solvent is also used in general.

Further, the resin forming the hard coat layer may contain additives such as the above optical stabilizer and the above ultraviolet absorbent as well as a catalyst, a thermo- or photo-polymerization initiator, a polymerization inhibitor, a silicone defoaming agent, a leveling agent, a thickener, a precipitation inhibitor, a sag inhibitor, a flame retardant and an organic or inorganic pigment or dye, and additive aids.

The coating technique may be suitably selected from among bar coating, dip coating, flow coating, spray coating, spin coating and roller coating techniques according to the shape of a molded article which becomes a substrate to be coated. Out of these, dip coating, flow coating and spray coating techniques are preferred because they are easily adaptable to the complicated shape of a molded article.

### <Lamp Lens for Vehicles>

Since polycarbonates (bisphenol A type) and amorphous resins such as acrylic resin are excellent in transparency and moldability, they are used in lamp lenses for vehicles such as automobiles, motorcycles and trains. As for lamp lenses for automobiles, they are used in head lamp lenses, rear lamp lenses, direction indicator lamp lenses and room lamp lenses. In addition to transparency and moldability, mechanical properties, weather resistance, heat resistance, dimensional stability, scratch resistance and low-temperature properties are required.

As for heat resistance, mechanical properties and dimensional stability in a 80 to 120° C. use environment are required due to heat generated from a lamp, and an amorphous resin must have a high glass transition temperature of, for example, 100° C. or higher, preferably 120° C. or higher. From this point of view, acrylic resin has a glass transition temperature of 80 to 90° C., whereby its use is limited. Since polycarbonates have a glass transition temperature of 130 to 150° C., they can be used in almost all the fields of lamp lenses for automobiles from the viewpoint of heat resistance.

Scratch resistance is also an important factor for lamp lenses for automobiles. Although a hard coat film is formed on a head lamp lens to improve scratch resistance, if the resin has excellent scratch resistance, the hard coat film can be made thin. Therefore, high surface hardness and excellent scratch resistance are required for lamp lenses for automobiles including head lamp lenses. When surface hardness is low, the surface of a lamp lens is scratched by sand scattered during driving, whereby the lens is easily scratched and its transparency tends to lower.

Weather resistance is required for lamp lenses for vehicles which are used outdoors. Especially a head lamp lens must not yellow even when it is used for a long time. While acrylic resin is rarely discolored by ultraviolet light, as polycarbonates are yellowed by ultraviolet light, a large amount of an ultraviolet absorbent must be used, thereby producing a large amount of a gas during molding with the result that the precision transfer of a mold surface tends to become difficult, or the surface of a molded article tends to become clouded.

Since it is possible that a lamp lens for vehicles is used in cold districts, it is desired that it should have high impact strength even at a low temperature.

Polycarbonates and acrylic resin are generally produced by using raw materials derived from oil resources. Due to concerns about the depletion of oil resources and an increasing amount of carbon dioxide in the air causing global warming, a great deal of attention is now paid to biomass resources whose raw materials do not depend on oil and which materialize “carbon neutral” without increasing the amount of carbon dioxide even when they are burnt. In the field of polymers, the development of biomass plastics produced from the biomass resources is now actively under way.

A typical example of the biomass plastics is polylactic acid. Since the polylactic acid has relatively high heat resistance and mechanical properties among the biomass plastics, its use is spreading to dishes, packaging materials and miscellaneous goods, and further the potential for using it as an industrial material is now under study.

However, for use of the polylactic acid as an industrial material, its heat resistance is unsatisfactory and when a molded article thereof is to be obtained by injection molding having high productivity, it is inferior in moldability as its crystallinity is low as a crystalline polymer.

A polycarbonate which is produced from a raw material obtained from an ether diol residue able to be produced from sugar is under study as an amorphous polycarbonate having high heat resistance which is obtained from a biomass resource. Especially, studies have been made to use mainly isosorbide as a monomer so as to incorporate it into a polycarbonate.

### (Production of Lamp Lens for Vehicles)

The lamp lens for vehicles of the present invention is molded from the above polycarbonate by an arbitrary method such as injection molding. In the case of the injection molding method, molding is preferably carried out at a mold temperature of 30 to 120° C. and a resin temperature of 220 to 290° C. Further, the lamp lens for vehicles of the present invention may be subjected to various surface treatments. The terms “surface treatment” used herein means the formation of a new layer on the surface layer of a resin molded article by vapor deposition (such as physical vapor deposition or chemical vapor deposition), plating (such as electroplating, electroless plating or hot-dip plating), painting, coating or printing. Techniques which are used for ordinary polycarbonates can be used. The surface treatments include hard coating, water-repellent or oil-repellent coating, ultraviolet absorption coating, infrared absorption coating and metallizing (deposition). Hard coating is particularly preferred and a required surface treatment. Preferred examples of the lamp lens for vehicles include head lamp lenses rear lamp lenses, direction indicator lamp lenses and room lamp lenses for automobiles, motorcycles and trains. Out of these, head lamp lenses are preferred.

### <Plastic Lens>

Another object of the present invention is to provide a plastic lens which is excellent in balance among heat resistance, cold resistance, transparency, impact strength, scratch resistance and optical properties. The inventors of the present invention conducted intensive studies and found that a polycarbonate composition comprising isosorbide is excellent in balance among heat resistance, cold resistance, transparency, impact strength, scratch resistance and optical properties. The present invention was accomplished based on this finding.

The plastic lens of the present invention is excellent in balance among heat resistance, cold resistance, transparency, impact strength, scratch resistance and optical properties. The plastic lens of the present invention is useful as a spectacle lens or sunglass lens which needs to cut off a specific wavelength.

The present invention is a plastic lens which is formed from a polycarbonate containing (i) a carbonate unit (A) represented by the following formula and having (ii) a specific viscosity measured with a 20° C. methylene chloride solution of 0.3 to 0.8, (iii) a glass transition temperature of 100° C. or higher, (iv) a pencil hardness of at least HB and (v) a total light transmittance of 80% or more and which (vi) does not crack with a falling ball having a weight of at least 68 g in a falling ball test based on ANSI Z87.1 standard at 25° C., and (vii) has an in-plane phase difference of 50 nm or less at a thickness of 2.0 mm.

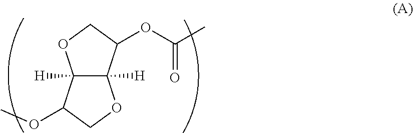

### (Polycarbonate)

The polycarbonate used in the present invention contains the unit (A) represented by the above formula. The unit (A) is contained in an amount of preferably 15 mol % or more, more preferably 30 mol % or more, much more preferably 50 mol % or more based on the total of all the carbonate units.

### (Unit (A))

The unit (A) in the present invention is derived from an aliphatic diol having an ether group as shown in the above formula (A).

The above formula (A) shows a diol having an ether bond which is a material having high heat resistance and high pencil hardness among biomass resources.

Examples of the above formula (A) include units (A1), (A2) and (A3) which are represented by the following formulae and stereoisomeric to one another.

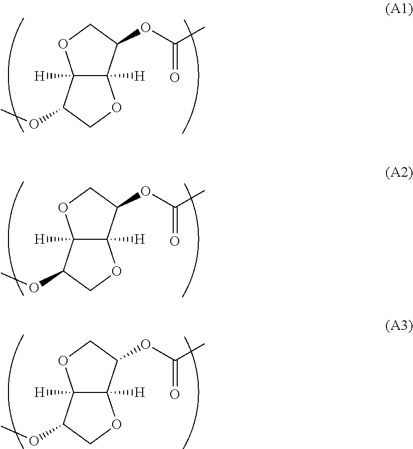

They are sugar-derived ether diols, obtained from the biomass of the natural world and called “renewable resources” The units (A1), (A2) and (A3) are called isosorbide, isommanide and isoidide, respectively. Isosorbide is obtained by hydrogenating D-glucose obtained from starch and dehydrating the obtained product. The other ether diols are obtained from a similar reaction except for the starting material.

The recurring unit derived from isosorbide (1,4:3,6-dianhydro-D-sorbitol) out of isosorbide, isomannide and isoidide is particularly preferred because it is easily produced and has excellent heat resistance.

### (Unit (b)

The polycarbonate contains the unit (A) and a carbonate unit (b) derived from at least one compound selected from the group consisting of an aliphatic diol compound and an alicyclic diol compound, and the (A/b) molar ratio of the unit (A) to the unit (b) is preferably 15/85 to 95/5.

When the (A/b) molar ratio of the unit (A) to the unit (b) is 15/85 to 95/5, heat resistance becomes high and moldability becomes satisfactory. The (A/b) molar ratio of the unit (A) to the unit (b) is preferably 30/70 to 95/5, more preferably 40/60 to 95/5, particularly preferably 50/50 to 95/5, most preferably 60/40 to 95/5. When the (A/b) molar ratio is lower than 15/85, heat resistance tends to degrade and when the (A/b) molar ratio is higher than 95/5, melt viscosity becomes high, thereby deteriorating moldability, whereby impact resistance tends to become worse. The molar ratio of each recurring unit is calculated by measurement with the proton NMR of JNM-AL400 of JEOL Ltd.

The total content of the unit (A) and the unit (b) of the polycarbonate is preferably 70 mol % or more, more preferably 80 mol % or more, much more preferably 90 mol % or more, particularly preferably 95 mol % or more, most preferably 100 mol % based on the total of all the carbonate units.

The unit (b) is a carbonate unit (b) derived from at least one compound selected from the group consisting of an aliphatic diol compound and an alicyclic diol compound. The aliphatic diol compound may be either a linear aliphatic diol compound or a branched aliphatic diol compound.

As the linear aliphatic diol compound, a linear aliphatic diol compound having preferably 2 to 30 carbon atoms, more preferably 3 to 20 carbon atoms, much more preferably 3 to 10 carbon atoms is used. Examples of the linear aliphatic diol compound include ethylene glycol, 1,3-propanediol, 1,4-butanediol, 1,5-pentanediol, neopentyl glycol, 1,6-hexanediol, 1,7-heptanediol, 1,8-octanediol, 1,9-nonanediol, 2-ethyl-1,6-hexanediol, 2,2,4-trimethyl-1,6-hexanediol, 1,10-decanediol, 1,12-dodecanediol, hydrogenated dilinoleyl glycol and hydrogenated dioleyl glycol. Out of these, 1,3-propanediol, 1,4-butanediol, 1,6-hexanediol, 1,9-nonanediol, 1,10-decanediol and 1,12-dodecanediol are preferred.

As the branched aliphatic diol compound, a branched aliphatic diol compound having preferably 3 to 30 carbon atoms, more preferably 3 to 20 carbon atoms, much more preferably 4 to 12 carbon atoms is used. Examples of the branched aliphatic diol compound include 1,3-butylene glycol, 2-methyl-1,3-propanediol, neopentyl glycol, 3-methyl-1,5-pentanediol, 2-n-butyl-2-ethyl-1,3-propanediol, 2,2-diethyl-1,3-propanediol, 2,4-diethyl-1,5-pentanediol, 1,2-hexane glycol, 1,2-octyl glycol, 2-ethyl-1,3-hexanediol, 2,3-diisobutyl-1,3-propanediol, 2,2-diisoamyl-1,3-propanediol and 2-methyl-2-propyl-1,3-propanediol. Out of these, 3-methyl-, 5-pentanediol, 2-n-butyl-2-ethyl-1,3-propanediol, 2,2-diethyl-1,3-propanediol and 2,4-diethyl-1,5-pentanediol are preferred.

As the alicyclic diol compound, an alicyclic diol compound having preferably 6 to 30 carbon atoms, more preferably 6 to 20 carbon atoms is used. Examples of the alicyclic diol compound include cyclohexanediols such as 1,2-cyclohexanediol, 1,3-cyclohexanediol, 1,4-cyclohexanediol and 2-methyl-1,4-cyclohexanediol; cyclohexanedimethanols such as 1,2-cyclohexanedimethanol, 1,3-cyclohexanedimethanol and 1,4-cyclohexanedimethanol; norbornanedimethanols such as 2,3-norbornanedimethanol and 2,5-norbornanedimethanol; and tricyclodecanedimethanol, pentacyclopentadecanedimethanol, 1,3-adamantanediol, 2,2-adamantanediol, decalindimethanol, 2,2,4,4-tetramethyl-1,3-cyclobutanediol and 3,9-bis(2-hydroxy-1,1-dimethylethyl)-2,4,8,10-tetraoxaspiro[5.5]undecane. Out of these, 1,4-cyclohexanedimethanol, tricyclodecanedimethanol and 3,9-bis(2-hydroxy-1,1-dimethylethyl)-2,4,8,10-tetraoxaspiro[5.5]undecane are preferred.

These aliphatic diol compounds and these alicyclic diol compounds may be used alone or in combination of two or more. As the diol used in the present invention, an aromatic diol may be used as long as the effect of the present invention is not impaired. Examples of the aromatic dihydroxy compound include α,α′-bis(4-hydroxyphenyl)-m-diisopropylbenzene (bisphenol M), 9,9-bis(4-hydroxy-3-methylphenyl)fluorene, 1,1-bis(4-hydroxyphenyl)cyclohexane, 1,1-bis(4-hydroxyphenyl)-3,3,5-trimethylcyclohexane, 4,4′-dihydroxy-3,3′-dimethyldiphenyl sulfide, bisphenol A, 2,2-bis(4-hydroxy-3-methylphenyl)propane (bisphenol C), 2,2-bis(4-hydroxyphenyl)-1,1,1,3,3,3-hexafluoropropane (bisphenol AF) and 1,1-bis(4-hydroxyphenyl)decane.

A preferred example of the polycarbonate is a copolycarbonate which contains the above unit (A) and a unit (b-1) represented by the following formula (b-1) and has a total content of the unit (A) and the unit (b-1) of 80 mol % or more, preferably 90 mol % or more based on the total of all the recurring units.

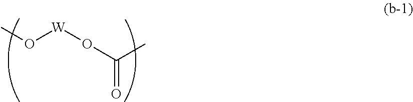

In the above formula, W is an alkylene group having 8 to 12 carbon atoms. Examples of the alkylene group having 8 to 12 carbon atoms include octylene group, nonylene group, decylene group and dodecylene group.

The unit (b-1) is derived from an aliphatic diol having 8 to 12 carbon atoms. Examples of the aliphatic diol having 8 to 12 carbon atoms include 1,8-octanediol, 1,9-nonanediol, 1,10-decanediol, 1,12-dodecanediol, 2,4-diethyl-1,5-pentanediol and 2-methyl-1,8-octanediol. Out of these, 1,8-octanediol, 1,9-nonanediol, 1,10-decanediol and 1,12-dodecanediol are preferred, and 1,9-nonanediol, 1,10-decanediol and 1,12-dodecanediol are more preferred. They may be used in combination of two or more.

The (A/(b-1)) molar ratio of the unit (A) to the unit (b-1) is preferably 60/40 to 95/5, more preferably 70/30 to 95/5, much more preferably 80/20 to 95/5, particularly preferably 90/10 to 95/5. Within the above range, balance among heat resistance, cold resistance, transparency, impact strength, scratch resistance and optical properties becomes excellent advantageously. The (A/(B-1)) molar ratio can be calculated by measurement with the proton NMR of JNM-AL400 of JEOL Ltd.

(Specific Viscosity: ηₛₚ)

The specific viscosity (ηₛₚ) of the polycarbonate is preferably 0.3 to 0.8, more preferably 0.32 to 0.6, much more preferably 0.33 to 0.50, particularly preferably 0.34 to 0.45, most preferably 0.34 to 0.4. When the specific viscosity is 0.3 to 0.8, strength and moldability become high. When the specific viscosity of the polycarbonate of the present invention is lower than 0.3, strength degrades and when the specific viscosity is higher than 0.8, moldability deteriorates disadvantageously.

The specific viscosity is obtained from a solution prepared by dissolving 0.7 g of the polycarbonate in 100 ml of methylene chloride at 20° C. by using an Ostwald viscometer.

Specific viscosity (ηₛₚ)=(t−t₀)/t₀

[“t₀” is the number of seconds required for the dropping of methylene chloride, and “t” is the number of seconds required for the dropping of a sample solution]

The measurement of the specific viscosity may be carried out, for example, by the following procedure. The polycarbonate is first dissolved in methylene chloride in an amount which is 20 to 30 times the weight of the polycarbonate, soluble matter is collected by cerite filtration, the solution is removed, and the residue is fully dried to obtain a methylene chloride-soluble solid. The specific viscosity at 20° C. is obtained from a solution prepared by dissolving 0.7 g of the solid in 100 ml of methylene chloride by using an Ostwald viscometer.

### (Glass Transition Temperature: Tg)

The glass transition temperature (Tg) of the polycarbonate is preferably 100 to 150° C., more preferably 105 to 140° C., much more preferably 120 to 140° C. When the glass transition temperature (Tg) is 120 to 130° C., heat resistance stability and moldability become satisfactory at the time of using the polycarbonate as an optical molded article advantageously.

When the glass transition temperature (Tg) of the polycarbonate is lower than 100° C., the heat resistance of a molded article tends to become unsatisfactory. When the glass transition temperature of the polycarbonate of the present invention is higher than 150° C., injection moldability tends to deteriorate. The glass transition temperature (Tg) is measured at a temperature elevation rate of 20° C./min by using the 2910 DSC of TA Instruments Japan.

### (Total Light Transmittance)

A molded article having a thickness of 2.0 mm formed by injection molding the polycarbonate has a total light transmittance of 80% or more, preferably 85% or more, more preferably 88% or more, much more preferably 88.5% or more, particularly preferably 89% or more. The upper limit of the total light transmittance is preferably 95%, more preferably 94%, much more preferably 93%. A 2.0 mm-thick molded article of the resin composition used in the present invention preferably has a haze of 0.3 to 20%. The haze is more preferably 0.3 to 10%, much more preferably 0.5 to 10%, particularly preferably 0.6 to 5%, most preferably 0.7 to 3%.

The term “total light transmittance” used in association with the present invention indicates the level of transparency and means the ratio of transmitted light to incident light measured by the method E308 of ASTM-D1003-61. The term “haze” used in association with the present invention indicates the level of transparency and means the percentage (%) of transmitted light deviated from an incident light flux by forward scattering when it passes through a test specimen (ASTM-D1003-61). That is, as the total light transmittance becomes higher and the haze becomes lower, transparency becomes higher.

### (Photoelastic Coefficient)

The absolute value of photoelastic coefficient of the polycarbonate is preferably 30×10⁻¹² Pa⁻¹ or less, more preferably 28×10⁻¹² Pa⁻¹ or less, particularly preferably 20×10⁻¹² Pa⁻¹ or less. When the absolute value is 30×10⁻¹² Pa⁻¹ or less, optical strain is hardly produced by stress, whereby the obtained lens is preferred as an optical lens.

### (Pencil Hardness)

The polycarbonate has a pencil hardness of at least HB, preferably at least F. The pencil hardness is more preferably at least H since scratch resistance becomes excellent. The pencil hardness can be enhanced by increasing the content of the recurring unit (B) based on the total of all the recurring units. In the present invention, the term “pencil hardness” means hardness that when a resin is rubbed with a pencil having specific pencil hardness, no scratch mark is left, and pencil hardness used in the surface hardness test of a film which can be measured in accordance with JIS K-5600 is used as an index. The pencil hardness becomes lower in the order of 9H, 8H, 7H, 6H, 5H, 4H, 3H, 2H, H, F, HB, B, 2B, 3B, 4B, 5B and 6B, 9H is the hardest, and 6B is the softest.

### (Production Method of Polycarbonate)

The polycarbonate is produced by reaction means known per se for producing an ordinary polycarbonate, for example, a method in which a diol component is reacted with a carbonate precursor such as diester carbonate. A brief description is subsequently given of basic means for these production methods.

A transesterification reaction using a diester carbonate as the carbonate precursor is carried out by stirring an aromatic dihydroxy component and the diester carbonate in a predetermined ratio under heating in an inert gas atmosphere and distilling off the formed alcohol or phenol. The reaction temperature which differs according to the boiling point of the formed alcohol or phenol is generally 120 to 300° C. The reaction is completed while the formed alcohol or phenol is distilled off by setting a reduced pressure from the beginning. An end sealing agent and an antioxidant may be added as required.

The diester carbonate used in the above transesterification reaction is an ester such as an aryl group or aralkyl group having 6 to 12 carbon atoms which may be substituted. Specific examples thereof include diphenyl carbonate, ditolyl carbonate, bis(chlorophenyl)carbonate and m-cresyl carbonate. Out of these, diphenyl carbonate is particularly preferred. The amount of diphenyl carbonate is preferably 0.97 to 1.10 moles, more preferably 1.00 to 1.06 moles based on 1 mole of the total of the dihydroxy compounds.

To increase the polymerization rate in the melt polymerization method, a polymerization catalyst may be used, as exemplified by an alkali metal compound, an alkali earth metal compound, a nitrogen-containing compound and a metal compound.

As the above compounds, organic acid salts, inorganic salts, oxides, hydroxides, hydrides, alkoxides and quaternary ammonium hydroxides of an alkali metal or an alkali earth metal are preferably used, and these compounds may be used alone or in combination.

Examples of the alkali metal compound include sodium hydroxide, potassium hydroxide, cesium hydroxide, lithium hydroxide, sodium hydrogen carbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenylphosphate, disodium salts, dipotassium salts, dicesium salts and dilithium salts of bisphenol A, and sodium salts, potassium salts, cesium salts and lithium salts of phenol.

Examples of the alkali earth metal compound include magnesium hydroxide, calcium hydroxide, strontium hydroxide, barium hydroxide, magnesium carbonate, calcium carbonate, strontium carbonate, barium carbonate, calcium hydrogen carbonate, barium hydrogen carbonate, magnesium hydrogen carbonate, strontium hydrogen carbonate, magnesium diacetate, calcium diacetate, strontium diacetate and barium diacetate. Examples of the basic boron compound include sodium salts, potassium salts, lithium salts, calcium salts, barium salts, magnesium salts and strontium salts of tetramethylboron, tetraethylboron, tetrapropylboron, tetrabutylboron, trimethylethylboron, trimethylbenzylboron, trimethylphenylboron, triethylmethylboron, triethylbenzylboron, triethylphenylboron, tributylbenzylboron, tributylphenylboron, tetraphenylboron, benzyl triphenylboron, methyl triphenylboron and butyl triphenylboron.

Examples of the basic phosphorus compound include triethylphosphine, tri-n-propylphosphine, triisopropylphosphine, tri-n-butylphosphine, triphenylphosphine, tributylphosphine and quaternary phosphonium salts.

Examples of the nitrogen-containing compound include quaternary ammonium hydroxides having an alkyl or aryl group such as tetramethylammonium hydroxide, tetraethylammonium hydroxide, tetrapropylammonium hydroxide, tetrabutylammonium hydroxide and trimethylbenzylammonium hydroxide. Tertiary amines such as triethylamine, dimethylbenzylamine and triphenylamine, and imidazoles such as 2-methylimidazole, 2-phenylimidazole and benzimidazole may be used. Bases and basic salts such as ammonia, tetramethylammonium borohydride, tetrabutylammonium borohydride, tetrabutylammonium tetraphenylborate and tetraphenylammonium tetraphenylborate may also be used.

Examples of the metal compound include zinc aluminum compounds, germanium compounds, organic tin compounds, antimony compounds, manganese compounds, titanium compounds and zirconium compounds. These compounds may be used alone or in combination of two or more.

The amount of the polymerization catalyst is preferably 1×10⁻⁹ to 1×10⁻² equivalent, more preferably 1×10⁻⁸ to 1×10⁻⁵ equivalent, much more preferably 1×10⁻⁷ to 1×10⁻³ equivalent based on 1 mole of the diol component.

A catalyst deactivator may be added in the latter stage of the reaction. Known catalyst deactivators are used effectively as the catalyst deactivator. Out of these, ammonium salts and phosphonium salts of sulfonic acid are preferred. Salts of dodecylbenzenesulfonic acid such as tetrabutylphosphonium salts of dodecylbenzenesulfonic acid and salts of paratoluenesulfonic acid such as tetrabutylammonium salts of paratoluenesulfonic acid are more preferred.

As the ester of sulfonic acid, methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate and phenyl paratoluenesulfonate are preferably used. Out of these, tetrabutylphosphonium salts of dodecylbenzenesulfonic acid are most preferably used.

As for the amount of the catalyst deactivator, when at least one polymerization catalyst selected from alkali metal compounds and/or alkali earth metal compounds is used, the catalyst deactivator is used in an amount of preferably 0.5 to 50 moles, more preferably 0.5 to 10 moles, much more preferably 0.8 to 5 moles based on 1 mole of the catalyst. The polycarbonate may be mixed with additives such as a heat stabilizer, plasticizer, optical stabilizer, polymerization metal inactivating agent, flame retardant, lubricant, antistatic agent, surfactant, antibacterial agent, ultraviolet absorbent and release agent as required according to purpose.

### (Heat Stabilizer)

The polycarbonate preferably contains a heat stabilizer to suppress the reduction of molecular weight and the deterioration of color during extrusion/molding. Since the ether diol residue of the unit (A) tends to be deteriorated by heat and oxygen to be colored, a phosphorus-based stabilizer is preferably contained as the heat stabilizer. As the phosphorus-based stabilizer, a pentaerythritol type phosphite compound or a phosphite compound which reacts with a dihydric phenol and has a cyclic structure is more preferably used. Examples of these compounds are the same as those enumerated above.

The above phosphorus-based stabilizers may be used alone or in combination of two or more, and at least a pentaerythritol type phosphite compound or a phosphite compound having a cyclic structure is preferably used in an effective amount. The phosphorus-based stabilizer is used in an amount of preferably 0.001 to 1 part by weight, more preferably 0.01 to 0.5 part by weight, much more preferably 0.01 to 0.3 part by weight based on 100 parts by weight of the polycarbonate.

A hindered phenol-based heat stabilizer may be added as a heat stabilizer to the polycarbonate in combination with the phosphorus-based heat stabilizer so as to suppress the reduction of molecular weight and the deterioration of color during extrusion/molding.

Examples of the hindered phenol-based stabilizer are the same as those enumerated above.

The hindered phenol-based stabilizer is used in an amount of preferably 0.001 to 1 part by weight, more preferably 0.01 to 0.5 part by weight, much more preferably 0.01 to 0.3 part by weight based on 100 parts by weight of the polycarbonate.

### (Release Agent)

The polycarbonate may contain a release agent to further improve its releasability from a mold at the time of melt molding as long as the object of the present invention is not impaired. Examples of the release agent are the same as those enumerated above. These release agents may be used alone or in combination of two or more. The amount of the release agent is preferably 0.01 to 5 parts by weight based on 100 parts by weight of the polycarbonate.

### (Ultraviolet Absorbent)

The polycarbonate may contain an ultraviolet absorbent.

The ultraviolet absorbent is selected from a benzotriazole-based ultraviolet absorbent, benzophenone-based ultraviolet absorbent, triazine-based ultraviolet absorbent, cyclic imino-ester-based ultraviolet absorbent and cyanoacrylate-based ultraviolet absorbent, out of which a benzotriazole-based ultraviolet absorbent is preferred. Examples of these compounds are the same as those enumerated above.

The amount of the ultraviolet absorbent is preferably 0.01 to 2 parts by weight, more preferably 0.1 to 1 part by weight, much more preferably 0.2 to 0.5 part by weight based on 100 parts by weight of the polycarbonate.

### (Optical Stabilizer)

The polycarbonate may contain an optical stabilizer. When the polycarbonate contains an optical stabilizer, it is preferred in terms of weather resistance, and a molded article thereof is hardly cracked.

Examples of the optical stabilizer are the same as those enumerated above. The amount of the optical stabilizer is preferably 0.01 to 1 part by weight, more preferably 0.05 to 0.5 part by weight based on 100 parts by weight of the polycarbonate.

### (Bluing Agent)

The polycarbonate may contain a bluing agent to erase the yellow tint of a lens based on a polymer and an ultraviolet absorbent. A bluing agent which is used for polycarbonates may be used without any problem. In general, anthraquinone-based dyes are easily acquired and preferred.

Examples of the bluing agent are the same as those enumerated above. The bluing agent is used in an amount of 0.1×10⁻⁴ to 2×10⁻⁴ part by weight based on 100 parts by weight of the polycarbonate.

### (Colorant)

The polycarbonate is mixed with a dye or pigment as a colorant in order to darken a plastic lens or correct the coloring of the above ultraviolet absorbent. Examples of the dye or pigment include perylene-based dyes, coumalin-based dyes, thioindigo-based dyes, anthraquinone-based dyes, thioxanthone-based dyes, ferrocyanides such as Prussian blue, perinone-based dyes, quinoline-based dyes, quinacridone-based dyes, dioxazine-based dyes, isoindolinone-based dyes and phthalocyanine-based dyes. Further, fluorescent whitening agents such as bisbenzoxazolyl-stilbene derivatives, bisbenzoxazolyl-naphthalene derivatives, bisbenzoxazolyl-thiophene derivatives and coumalin derivatives may also be used. By using a metallic pigment, a good metallic color is obtained and the indoor temperature can be kept properly through moderate heat reflection. The amount of the above dye or pigment is preferably 0.0001 to 1 part by weight, more preferably 0.0005 to 0.8 part by weight based on 100 parts by weight of the polycarbonate.

### (Production Method of Resin Composition)

A resin composition comprising the polycarbonate and the above-described additives can be produced, for example, by premixing components and optional components, melt kneading them together and pelletizing the kneaded product. Examples of the premixing means include a Nauter mixer, a twin-cylinder mixer, a Henschel mixer, a mechanochemical device and an extrusion mixer. During premixing, the resulting mixture may be granulated by means of an extrusion granulator or a briquetting machine. After premixing, the obtained mixture is melt kneaded by means of a melt kneader typified by a vented double-screw extruder and pelletized by means of a device such as a pelletizer. Other examples of the melt kneader include a Banbury mixer, a kneading roll and a constant heat stirring vessel, and a vented double-screw extruder is preferred. Alternatively, the components and the optional components may be supplied into a melt kneader typified by a double-screw extruder independently without being premixed together. The cylinder temperature at the time of melt kneading is preferably 180 to 270° C., more preferably 190 to 260° C., much more preferably 200 to 250° C. When the cylinder temperature is higher than 270° C., the thermal decomposition of the polycarbonate is greatly promoted.

### (Plastic Lens)

The plastic lens of the present invention can be obtained by the injection molding or injection compression molding of the above polycarbonate. It can also be formed by the vacuum molding or compression molding of the polycarbonate.

In the case of injection molding, a plastic lens molded article is obtained by injection molding the polycarbonate into a lens form by means of an injection molding machine or an injection compression molding machine. The molding is preferably carried out at a cylinder temperature of 180 to 270° C. To suppress coloring and the reduction of molecular weight caused by the decomposition of the polymer, the cylinder temperature is more preferably 180 to 270° C., much more preferably 190 to 260° C. When the cylinder temperature is higher than 270° C., the decomposition of the polymer is greatly promoted. Although the mold temperature may be 40 to 140° C., to shorten the molding cycle and the melt residence time of the resin, the mold temperature is preferably 40 to 120° C., more preferably 40 to 100° C.

The thickness of the plastic lens obtained as described above may be suitably selected according to purpose but preferably 1 to 5 mm.

The plastic lens of the present invention is advantageously used in the form of an aspherical lens as required. Since a single aspherical lens can eliminate spherical aberration substantially, it is not necessary to use a plurality of spherical lenses so as to remove spherical aberration, thereby making it possible to reduce the weight of the plastic lens and cut the production cost thereof.

### (Hard Coat, Etc.)

The plastic lens of the present invention may be subjected to a post-processing treatment such as the formation of a hard coat (cured) layer, antireflection coat layer or antifogging coat layer on the surface as required. The hard coat layer to be formed on the surface of the lens substrate of the present invention is preferably thermally curable or curable with activation energy. Examples of the thermally curable hard coating material include silicone-based resins such as organopolysiloxane and melamine-based resins.

As the silicone-based resins, resins described in JP-A 48-056230, JP-A 49-014535, JP-A 08-054501 and JP-A 08-198985 may be used.

The hard coat layer is obtained by drying and/or thermally curing a coating composition comprising a melamine resin such as methylated methylolmelamine, propylated methylolmelamine, butylated methylolmelamine or isobutylated methylolmelamine, a crosslinking agent and a curing agent.

Another component may be added to the coating composition in addition to the above components as long as the physical properties of the obtained cured film are not impaired. For example, the coating composition may contain a curing agent for promoting a reaction, a particulate inorganic material for matching the refractive indices of various substrates and a surfactant for improving wettability at the time of coating and the smoothness of a cured film.

It is also possible to color the coating film by dispersing a colorant (dye and pigment) or a filler, or by dissolving an organic polymer. Further, an ultraviolet absorbent and an antioxidant may be added.

Means for applying to the substrate (plastic lens) of the coating composition is not particularly limited, and known techniques such as dip coating, spray coating, spin coating, bar coating, flow coating and roll coating may be employed. From the viewpoint of surface accuracy, dip coating and spin coating are preferably used.

A single-layer or multi-layer antireflection layer may be formed on the above cured layer as required.

As the constituent component of the antireflection layer, a conventionally known component such as an inorganic oxide, fluoride or nitride is used. Specific examples thereof include silicon dioxide, silicon monoxide, zirconium oxide, tantalum oxide, yttrium oxide, aluminum oxide, titanium oxide, magnesium fluoride and silicon nitride. Examples of the method of forming the antireflection layer include vacuum vapor deposition, sputtering, ion plating and ion beam assisted method. Antireflection performance is improved by forming this antireflection layer. Further, the antifogging layer may be formed on the above cured layer or antireflection layer.

### (Phase Difference of Lens)

The in-plane phase difference at a wavelength of 550 nm of the plastic lens of the present invention is 50 nm or less, preferably 45 nm or less, more preferably 40 nm or less. When the in-plane phase difference exceeds 50 nm, color unevenness such as a rainbow pattern or distortion becomes worse disadvantageously.

### (Impact Resistance)

The evaluation of impact resistance is generally carried out based on the US FDA standards in which impact resistance is evaluated according to a state when a steel ball having a weight of about 16.4 g is naturally dropped on a lens from a height of 127 cm above the lens to collide with the lens.

Further, an evaluation method in which a 68 g steel ball having a diameter of 25.4 mm is dropped on industrial safety glasses from a height of 127 cm is specified in the American National Standards (ANSI Z87.1 1989) as a standard for ensuring the safety of a wearer so as to further improve the safety of the wearer.

Since the inventors of the present invention were aimed to develop spectacle lenses having high safety and impact resistance which satisfies requirements for industrial use in order to ensure the high safety of a person wearing glasses, as a method for evaluating the impact resistance of a lens, they checked and judged the degrees of “breakage, chipping and cracking” by dropping an ANSI Z87.1-based steel ball (68 g) or a steel ball having a weight (357 g) several times larger than the weight of the above steel ball from a height of 127 cm.

It is preferred that a plastic lens should not be cracked with a falling ball having a weight of at least 357 g in a falling ball test based on ANSI Z87.1 standards at 25° C.

Further, in order to evaluate impact strength in a low-temperature environment, in addition to the test at normal temperature (25° C.), a falling ball test in a −20° C. environment was carried out. As a practical level of safety, it is required that a plastic lens should not crack in a 68 g falling ball test, it is preferred that a plastic lens should not crack in a 357 g falling ball test, and it is more preferred that a plastic lens should not crack in a falling ball test at −20° C. as a cold resistance performance as the safety of a spectacle lens. It is preferred that a plastic lens should not crack with a falling ball having a weight of at least 357 g in a falling ball test based on ANSI Z87.1 standard at −20° C.

### EXAMPLES

The following examples are provided for the purpose of further illustrating the present invention but are in no way to be taken as limiting. “Parts” in examples means “parts by weight”. Polymers and evaluation methods used in examples are as follows.

### 1. Copolymerization Ratio (NMR)

Recurring units were measured with the proton NMR of JNM-AL400 of JEOL Ltd. to calculate the copolymerization ratio (molar ratio).

### 2. Specific Viscosity

A solution prepared by dissolving 0.7 g of a polycarbonate pellet in 100 ml of methylene chloride was used to measure its specific viscosity at 20° C. by using an Ostwald viscometer (name of device: RIGO AUTO VISCOSIMETER TYPE VMR-0525-PC).

Specific viscosity (ηₛₚ)=(t−t₀)/t₀

[“t₀” is the number of seconds required for the dropping of methylene chloride, and “t” is the number of seconds required for the dropping of a sample solution]

### 3. Glass Transition Temperature

8 mg of a polycarbonate pellet was used to measure its glass transition temperature in a nitrogen atmosphere (nitrogen flow rate: 40 ml/min) at a temperature elevation rate of 20° C./min based on JIS K7121 by using the DSC-2910 thermal analyzing system of TA Instruments.

### 4. Water Absorption Coefficient (Wa)

A cast film having a thickness of 200 μm obtained by evaporating methylene chloride after a polycarbonate pellet was dissolved in methylene chloride was dried at 100° C. for 12 hours and immersed in 25° C. water for 72 hours to measure its weight increase so as to obtain its water absorption coefficient by the following equation.

Water absorption coefficient (%)={(weight of polymer after water absorption−weight of polymer before water absorption)/weight of polymer before water absorption}×100

### 5. TW Value

The TW value was obtained from the following equation.

TW value=glass transition temperature (Tg)×0.04−water absorption coefficient (Wa)

### 6. Pencil Hardness

A polycarbonate pellet was molded into a 2 mm-thick rectangular plate at a cylinder temperature of 250° C., a mold temperature of 80° C. and a molding cycle of 1 minute by using the J85-ELIII injection molding machine of The Japan Steel Works, Ltd. (JSW) to measure the pencil hardness of the molded test piece by the JIS K5600 base map plate test method.

### 7. Dynamic Viscoelasticity

After the obtained polycarbonate pellet was vacuum-dried at 100° C. for 24 hours, it was molded into a 2 mm-thick plate by using the 75-ton molding machine (JSW J-75EIII) of The Japan Steel Works, Ltd. (JSW). The dynamic viscoelasticity of the above molded piece was measured under the following conditions to obtain a temperature (Tₘₐₓ: ° C.) at which the loss tangent (tan δ) became maximum.

Name of device: RDAIII of TA Instruments Japan
Test specimen: 2.0 mm in thickness×12.0 mm in width
Measurement temperature: −20 to 100° C.
Temperature elevation rate: 2° C./min

### Frequency: 10 Hz

### 8. Low-Temperature Surface Impact

A 2 mm-thick rectangular plate was used to carry out a high-speed surface impact test 10 times at a test temperature of −20° C., a test speed of 7 m/sec, a striker diameter of ½ inch and a receptor diameter of 1 inch by using the HYDROSHOTHITS-P10 high-speed impact tester of Shimadzu Corporation so as to evaluate the probability that the fracture morphology became brittle fracture and maximum impact energy (average value) at that point.

### 9. Weather Discoloration

An irradiation treatment was carried out on the square surface of an injection molded flat plate (60 mm in width×60 mm in length×3 mm in thickness) at a black panel temperature of 63° C. and a relative humidity of 50% with irradiation and surface spray (rainfall) by using the S80 sunshine weatherometer of Suga Test Instruments Co., Ltd. and setting discharge voltage to 50 V and discharge current to 60 A with a sunshine carbon arc (4 pairs of ultra long-life carbons) light source for a predetermined time in accordance with JIS B7753. The surface spray (rainfall) time was 12 minutes/1 hour. An A-type glass filter was used. The color difference ΔE of the test piece before and after the test was measured by using the SE-2000 spectroscopic color difference meter of Nippon Denshoku Industries Co., Ltd. As ΔE becomes smaller, discoloration becomes smaller.

In Examples I-1 to I-11 and Comparative Examples I-1 to 1-6, the irradiation time was 500 hours. In Examples II-1 to II-10 and Comparative Examples II-1 to 11-7, the irradiation time was 1,000 hours.

### 10. Number Average Molecular Weight of Polycarbonate Oligomer

Polycarbonate copolymers in Examples II-5 and II-6 were dissolved in CDCl₃ to calculate the terminal hydroxyl group, the terminal phenyl group and the average number of recurring units with the proton NMR of JNM-A1400 of JEOL Ltd. so as to obtain the number average molecular weights of polycarbonate oligomers.

Number average molecular weight of polycarbonate oligomer=(integrated value of signals of recurring unit)/(integrated value of signals of terminal hydroxyl group+integrated value of signals of terminal phenyl group)×2×molecular weight of recurring unit

### 11. Average Number of Recurring Units (B-2) and Number Average Molecular Weight of Recurring Unit (B-2) in Polycarbonate Copolymer in Examples I-6 to I-9 and Examples II-5 to II-6

The polycarbonate copolymer was dissolved in CDCl₃ to be measured with ¹³C-NMR of JNM-AL400 of JEOL Ltd. The signal of ISS (isosorbide)-ISS carbonate is usually measured at 153 to 154 ppm, the signal of ISS-copolymerization diol is usually measured at 154 to 155 ppm, and the signal of copolymerization diol-copolymerization diol is generally measured at 155 to 156 ppm. The average number of recurring units was calculated from the integrated value of these signals. The number average molecular weight of the recurring unit (B-2) was obtained by multiplying the average number of the recurring units by the molecular weight of the recurring unit.

Average number of recurring units (B-2)=(integrated value of signals of [unit (B-2)−unit (B-2)]/integrated value of signals of [unit (A)−unit (B-2)]×2+1

### Example I-1

### Polymerization

436 parts of isosorbide (to be abbreviated as ISS), 65 parts of 1,8-octanediol (to be abbreviated as OD hereinafter), 750 parts of diphenyl carbonate (to be abbreviated as DPC hereinafter, and 0.8×10⁻² part of tetramethylammonium hydroxide and 0.6×10⁻⁴ part of sodium hydroxide as catalysts were heated at 180° C. in a nitrogen atmosphere to be molten. Thereafter, the degree of vacuum was adjusted to 13.4 kPa over 30 minutes. After the temperature was raised up to 250° C. at a rate of 60° C./hr and maintained at that temperature for 10 minutes, the degree of vacuum was set to 133 Pa or less over 1 hour. A reaction was carried out under agitation for a total of 6 hours, nitrogen was discharged from the bottom of a reaction tank under increased pressure after the end of the reaction, and the obtained product was cut with a pelletizer to obtain a pellet while it was cooled in a water tank.

### (Resin Composition)

0.4 part by weight of 2-(3-tert-butyl-5-methyl-2-hydroxyphenyl)-5-chloro-2H-benzotriazole which is a benzotriazole type ultraviolet absorbent as an ultraviolet absorbent, 0.1 part by weight of ADK STAB LA-77Y (of ADEKA Corporation) which is a secondary amine compound as an optical stabilizer and 0.1 part by weight of Irgafos 168 (manufactured by BASF; tris(2,6-di-tert-butylphenyl)phosphite) which is a phosphorus-based stabilizer as an antioxidant were uniformly mixed with 100 parts by weight of the obtained pellet, and the resulting mixture was injected into an extruder to produce a resin composition. A vented double-screw extruder having a diameter of 30 mm (TEX30α-35BW-3V of The Nippon Steel Works, Ltd.) was used as the extruder. As extrusion conditions, the discharge rate was set to 30 to 40 kg/hr, the screw revolution was set to 250 rpm, the vacuum degree of the vent was set to 3 kPa and the extrusion temperature from the first feed port to the dice part was set to 230° C. to obtain apellet. The evaluation results are shown in Table I.

### (Resin Window)

The dried pellet was used to mold a 150 mm² flat and smooth rectangular plate molded article having a thickness of 1 mm at a cylinder temperature of 240° C., a mold temperature of 80° C. and a molding cycle of 40 seconds by using an injection molding machine (manufactured by Toshiba Machine Co., Ltd.: IS-150EN). When the obtained molded article was cut out and attached to a window frame to be used as a fixed triangle window for the rear seat of a car, it was a window having good appearance and excellent surface hardness and weather resistance.

### Example I-2

The same operation and the same evaluations as in Example I-1 were carried out except that 450 parts of ISS, 66 parts of 1,9-nonanediol (to be abbreviated as ND hereinafter) and 750 parts of DPC were used as raw materials. The results are shown in Table I.

### Example I-3

The same operation and the same evaluations as in Example I-1 were carried out except that 419 parts of ISS, 101 parts of 1,9-nonanediol (to be abbreviated as ND hereinafter) and 750 parts of DPC were used as raw materials. The results are shown in Table I.

### Example I-4

The same operation and the same evaluations as in Example I-2 were carried out except that 68 parts of 1,10-decanediol (to be abbreviated as DD hereinafter) was used in place of ND. The results are shown in Table I.

### Example I-5

The same operation and the same evaluations as in Example I-2 were carried out except that 68 parts of 1,12-dodecanediol (to be abbreviated as DDD hereinafter) was used as a raw material in place of ND. The results are shown in Table I.

### Example I-6

### Polycarbonate Oligomer

161 parts of 1,6-hexanediol (to be abbreviated as HD hereinafter), 257 parts of diphenyl carbonate (to be abbreviated as DPC hereinafter) and 0.4×10⁻² part of tetramethylammonium hydroxide as a catalyst were heated at 180° C. in a nitrogen atmosphere to be molten. Thereafter, the degree of vacuum was adjusted to 13.4 kPa over 2 hours, the temperature was raised to 200° C. over 2 hours, and the distilling phenol and the unreacted diol were removed under a reduced pressure of 500 Pa or less to obtain 190 parts of a HD homopolycarbonate oligomer (to be abbreviated as PCHD) having a molecular weight of 530 (average number of recurring units of 3.7).

### (Copolycarbonate)

74 parts of the obtained PCHD, 488 parts of isosorbide (to be abbreviated as ISS hereinafter), 750 parts of diphenyl carbonate (to be abbreviated as DPC hereinafter), and 0.8×10⁻² part of tetramethylammonium hydroxide and 0.6×10⁻⁴ part of sodium hydroxide as catalysts were heated at 180° C. in a nitrogen atmosphere to be molten. Thereafter, the 25 degree of vacuum was adjusted to 13.4 kPa over 30 minutes. After the temperature was raised up to 250° C. at a rate of 60° C./hr and maintained at that temperature for 10 minutes, the degree of vacuum was set to 133 Pa or less over 1 hour. A reaction was carried out under agitation for a total of 6 hours, nitrogen was discharged from the bottom of a reaction tank under increased pressure after the end of the reaction, and the obtained product was cut with a pelletizer to obtain a pellet while it was cooled in a water tank. The number of the recurring units (B-2) in the copolycarbonate was 3.5, and the molecular weight of the unit (B-2) in the copolycarbonate was 500.

### (Resin Composition)

0.4 part by weight of 2-(3-tert-butyl-5-methyl-2-hydroxyphenyl)-5-chloro-2H-benzotriazole which is a benzotriazole type ultraviolet absorbent as an ultraviolet absorbent, 0.1 part by weight of ADK STAB LA-77Y (of ADEKA Corporation) which is a secondary amine compound as an optical stabilizer and 0.1 part by weight of Irgafos 168 (manufactured by BASF; tris(2,4-di-tert-butylphenyl)phosphite) which is a phosphorus-based stabilizer as an antioxidant were uniformly mixed with 100 parts by weight of the obtained pellet, and the resulting mixture was injected into an extruder to produce a resin composition. A vented double-screw extruder having a diameter of 30 mm (TEX30α-35BW-3V of The Nippon Steel Works, Ltd.) was used as the extruder. As extrusion conditions, the discharge rate was set to 30 to 40 kg/hr, the screw revolution was set to 250 rpm, the vacuum degree of the vent was set to 3 kPa and the extrusion temperature from the first feed port to the dice part was set to 230° C. to obtain a pellet.

### (Resin Window)

The dried pellet was used to mold a 150 mm² flat and smooth rectangular plate molded article having a thickness of 1 mm at a cylinder temperature of 240° C., a mold temperature of 80° C. and a molding cycle of 40 seconds by using an injection molding machine (manufactured by Toshiba Machine Co., Ltd.: IS-150EN). When the obtained molded article was cut out and attached to a window frame to be used as a fixed triangle window for the rear seat of a car, it was a window having good appearance and excellent surface hardness and weather resistance. The evaluation results are shown in Table I.

### Example I-7

The same operation as in Example I-6 was carried out except that 94 parts of 2-methyl-1,5-pentanediol (to be abbreviated as MPD hereinafter) was used to obtain 189 parts of an MPD homopolycarbonate oligomer (to be abbreviated as PCMPD hereinafter) having a molecular weight of 520 (average number of recurring units of 3.6). The same operation and the same evaluations as in Example I-6 were carried out except that 74 parts of PCMPD was used in place of PCHD. The number of the recurring units (B-2) in the copolycarbonate was 3.4, and the molecular weight of the unit (B-2) in the copolycarbonate was 490. The results are shown in Table I.

### Example I-8

The same operation as in Example I-6 was carried out except that 188 parts of 1-cyclohexanedimethanol (to be abbreviated as CHDM hereinafter) was used to obtain 226 parts of a CHDM homopolycarbonate oligomer (to be abbreviated as PCCHDM hereinafter) having a molecular weight of 1,030 (average number of recurring units of 6.0). The same operation and the same evaluations as in Example I-6 were carried out except that 179 parts of PCCHDM was used in place of PCHD and 483 parts of ISS was used. The number of the recurring units (B-2) in the copolycarbonate was 5.6, and the molecular weight of the unit (B-2) in the copolycarbonate was 960. The results are shown in Table I.

### Example I-9

The same operation as in Example I-6 was carried out except that 208 parts of 1,9-nonanediol (to be abbreviated as ND hereinafter) was used to obtain 240 parts of an ND homopolycarbonate oligomer (to be abbreviated as PCND hereinafter) having a molecular weight of 530 (average number of recurring units of 2.8). The same operation and the same evaluations as in Example I-6 were carried out except that 74 parts of PCMPD was used in place of PCHD. The number of the recurring units (B-2) in the copolycarbonate was 2.6, and the molecular weight of the unit (B-2) in the copolycarbonate was 490. The results are shown in Table I.

### Example I-10

The same operation and the same evaluations as in Example I-1 were carried out except that 322 parts of ISS, 131 parts of 2,2,4,4-tetramethyl-1,3-cyclobutanediol (to be abbreviated as TMCB hereinafter), 62 parts of ND and 750 parts of DPC were used as raw materials. The results are shown in Table I.

### Example I-11

The same operation and the same evaluations as in Example I-1 were carried out except that 256 parts of ISS, 197 parts of 2,2,4,4-tetramethyl-1,3-cyclobutanediol (to be abbreviated as TMCB hereinafter), 62 parts of ND and 750 parts of DPC were used as raw materials. The results are shown in Table I.

### Comparative Example I-1

The same operation and the same evaluations as in Example I-1 were carried out except that 501 parts of ISS and 749.7 parts of DPC were used as raw materials. When the obtained molded article was cut out and attached to a window frame to be used as a fixed triangle window for the rear seat of a car, it was inferior in impact resistance and could not withstand use in cold districts. The results are shown in Table I.

### Comparative Example I-2

The same operation and the same evaluations as in Example I-1 were carried out except that 376 parts of ISS, 65 parts of 1,3-propanediol (to be abbreviated as PD hereinafter) and 750 parts of DPC were used as raw materials. The results are shown in Table I.

### Comparative Example I-3

The same operation and the same evaluations as in Example I-1 were carried out except that 425 parts of ISS, 61 parts of 1,6-hexanediol (to be abbreviated as HD hereinafter) and 750 parts of DPC were used as raw materials. The results are shown in Table I.

### Comparative Example I-4

The same operation and the same evaluations as in Example I-1 were carried out except that 347 parts of ISS, 161 parts of CHDM and 750 parts of DPC were used as raw materials. The results are shown in Table I.

### Comparative Example I-5

Evaluation results obtained by using bisphenol A type polycarbonate (Panlite L1225Z100M of Teijin Chemicals Ltd.) are shown in Table 1. When the obtained molded article was cutout and attached to a window frame to be used as a fixed triangle window for the rear seat of a car, it had low weather resistance and surface hardness and was therefore inferior to the molded articles of Examples.

### Comparative Example I-6

Evaluation results obtained by using polyacrylic resin (Acrypet MF of Mitsubishi Rayon Co., Ltd.) are shown in Table I. When the obtained molded article was cut out and attached to a window frame to be used as a fixed triangle window for the rear seat of a car, it was inferior in impact resistance and could not withstand use in cold districts.

TABLE I
(1/2)

| | | | | | water | | dynamic |
|---|---|---|---|---|---|---|---|
| | | | | | absorption | pencil | viscoelasticity |
| | | | specific | Tg | coefficient | hadrness | Tmax |
| | | composition | viscosity | ° C. | % | — | ° C. |
| Ex. I-1 | ISS/OD | 87/13 | 0.403 | 120 | 1.9 | H | −82 |
| Ex. I-2 | ISS/ND | 88/12 | 0.401 | 121 | 1.8 | H | −90 |
| Ex. I-3 | ISS/ND | 83/17 | 0.401 | 104 | 1.8 | F | −90 |
| Ex. I-4 | ISS/DD | 89/11 | 0.394 | 119 | 1.8 | H | −89 |
| Ex. I-5 | ISS/DDD | 90/10 | 0.398 | 120 | 1.7 | H | −88 |
| Ex. I-6 | ISS/PCHD | 85/15 | 0.392 | 119 | 1.9 | H | −86 |
| Ex. I-7 | ISS/PCMPD | 85/15 | 0.398 | 122 | 1.7 | H | −86 |
| Ex. I-8 | ISS/PCCHDM | 71/29 | 0.391 | 125 | 1.7 | H | −83 |
| Ex. I-9 | ISS/PCND | 88/12 | 0.395 | 122 | 1.7 | H | −87 |
| Ex. I-10 | ISS/TMCB/ND | 63/26/11 | 0.39 | 121 | 1.2 | 2H | −89 |
| Ex. I-11 | ISS/TMCB/ND | 50/39/11 | 0.40 | 110 | 1.0 | 2H | −88 |
| C. Ex. I-1 | ISS | 100 | 0.394 | 160 | 5.3 | H | −36 |
| C. Ex. I-2 | ISS/PD | 75/25 | 0.382 | 116 | 2.4 | F | −48 |
| C. Ex. I-3 | ISS/HD | 85/15 | 0.383 | 125 | 3.0 | H | −72 |
| C. Ex. I-4 | ISS/CHDM | 68/32 | 0.382 | 120 | 2.3 | F | — |

| | | | | | | |
|---|---|---|---|---|---|---|
| C. Ex. I-5 | Panlite L1225 | 0.68 | 160 | 0.2 | 2B | −83 |
| C. Ex. I-6 | Acrypet MF | — | 93 | 2.2 | 2H | — |

Ex.: Example
C. Ex.: Comparative Example
(2/2)

| | low-temperature | | | | |
|---|---|---|---|---|---|
| | impact test | | | | |
| | | | brittle | weather | |
| | fracture | energy | fracture rate | discoloration | |
| | morphology | J | % | [symbol] E | resin window |
| Ex. I-1 | Ductile | 22 | 40 | 0.3 | satisfactory |
| Ex. I-2 | Ductile | 48 | 0 | 0.3 | satisfactory |
| Ex. I-3 | Ductile | 44 | 0 | 0.3 | satisfactory |
| Ex. I-4 | Ductile | 43 | 10 | 0.3 | satisfactory |
| Ex. I-5 | Ductile | 45 | 10 | 0.4 | satisfactory |
| Ex. I-6 | Ductile | 32 | 20 | 0.3 | satisfactory |
| Ex. I-7 | Ductile | 38 | 20 | 0.5 | satisfactory |
| Ex. I-8 | Ductile | 36 | 20 | 0.3 | satisfactory |
| Ex. I-9 | Ductile | 39 | 20 | 0.3 | satisfactory |
| Ex. I-10 | Ductile | 40 | 20 | 0.3 | satisfactory |
| Ex. I-11 | Ductile | 39 | 20 | 0.4 | satisfactory |
| C. Ex. I-1 | brittle | 2 | 100 | 1.2 | Low-temperature |
| | | | | | impact properties: × |
| C. Ex. I-2 | brittle | 4 | 100 | 0.3 | Low-temperature |
| | | | | | impact properties: × |
| C. Ex. I-3 | brittle | 6 | 100 | 0.7 | Low-temperature |
| | | | | | impact properties: × |
| C. Ex. I-4 | brittle | 18 | 80 | 0.3 | Low-temperature |
| | | | | | impact properties: × |
| C. Ex. I-5 | Ductile | 68 | 0 | 3.1 | Weather resistance, |
| | | | | | surface hardness: × |
| C. Ex. I-6 | brittle | 1 | 100 | — | Impact properties: × |

Ex.: Example
C. Ex.: Comparative Example
×: not satisfactory

### Example II-1

### Polymerization

436 parts of isosorbide (to be abbreviated as ISS), 65 parts of 1,8-octanediol (to be abbreviated as OD hereinafter), 750 parts of diphenyl carbonate (to be abbreviated as DPC hereinafter), and 0.8×10⁻² part of tetramethylammonium hydroxide and 0.6×10⁻⁴ part of sodium hydroxide as catalysts were heated at 180° C. in a nitrogen atmosphere to be molten. Thereafter, the degree of vacuum was adjusted to 13.4 kPa over 30 minutes. After the temperature was raised up to 250° C. at a rate of 60° C./hr and maintained at that temperature for 10 minutes, the degree of vacuum was set to 133 Pa or less over 1 hour. A reaction was carried out under agitation for a total of 6 hours, nitrogen was discharged from the bottom of a reaction tank under increased pressure after the end of the reaction, and the obtained product was cut with a pelletizer to obtain a pellet while it was cooled in a water tank.

### (Resin Composition)

0.4 part by weight of 2-(3-tert-butyl-5-methyl-2-hydroxyphenyl)-5-chloro-2H-benzotriazole which is a benzotriazole type ultraviolet absorbent as an ultraviolet absorbent, 0.1 part by weight of ADK STAB LA-77Y (of ADEKA Corporation) which is a secondary amine compound as an optical stabilizer and 0.1 part by weight of Irgafos 168 (manufactured by BASF; tris(2,4-di-tert-butylphenyl)phosphite) which is a phosphorus-based stabilizer as an antioxidant were uniformly mixed with 100 parts by weight of the obtained pellet, and the resulting mixture was injected into an extruder to produce a resin composition. A vented double-screw extruder having a diameter of 30 mm (TEX30α-35BW-3V of The Nippon Steel Works, Ltd.) was used as the extruder. As extrusion conditions, the discharge rate was set to 30 to 40 kg/hr, the screw revolution was set to 250 rpm, the vacuum degree of the vent was set to 3 kPa, and the extrusion temperature from the first feed port to the dice part was set to 230° C. to obtain a pellet. The evaluation results are shown in Table II.

### (Lamp Lens for Vehicles)

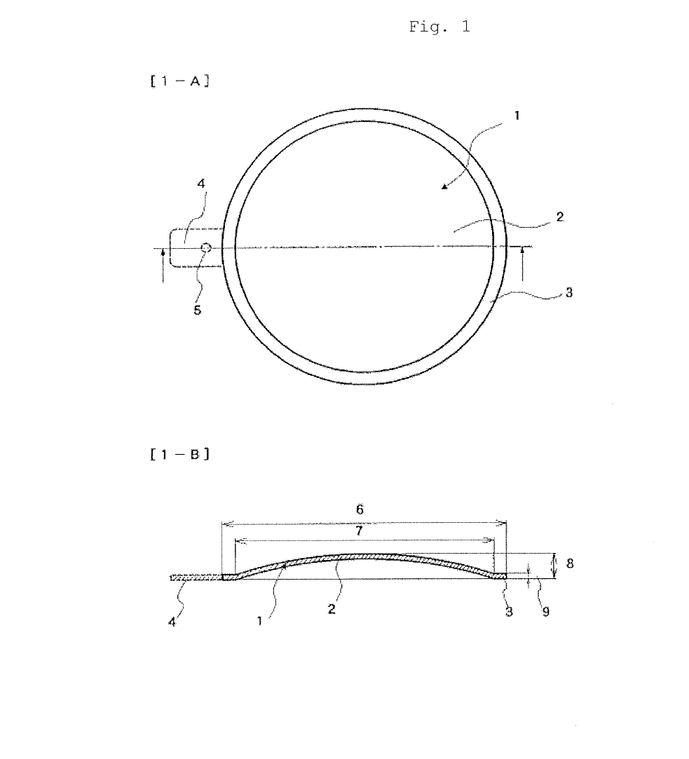

After the pellet obtained above was dried at 100° C. for 5 hours by means of a hot air circulation drying machine, the dried pellet was molded into a plain head lamp lens molded article shown in FIG. 1 at a cylinder temperature of 240° C., a mold temperature of 80° C., an injection rate of 50 mm/sec and a molding cycle of 70 seconds by using the SG260M-HP of Sumitomo Heavy Industries, Ltd. The head lamp lens was satisfactory in terms of appearance such as color and transparency, weather resistance and surface hardness.

### Example II-2

The same operation and the same evaluations as in Example II-1 were carried out except that 441 parts of ISS, 66 parts of 1,9-nonanediol (to be abbreviated as ND hereinafter) and 750 parts of DPC were used as raw materials. The results are shown in Table II.

### Example II-3

The same operation and the same evaluations as in Example II-2 were carried out except that 71 parts of 1,10-decanediol (to be abbreviated as DD hereinafter) was used in place of ND. The results are shown in Table II.

### Example II-4

The same operation and the same evaluations as in Example II-1 were carried out except that 451 parts of ISS, 69 parts of 1,12-dodecanediol (to be abbreviated as DDD hereinafter) and 750 parts of DPC were used as raw materials. The results are shown in Table II.

### Example II-5

### (1) Polycarbonate Oligomer

161 parts of 1,6-hexanediol (to be abbreviated as HD hereinafter), 257 parts of DPC and 0.4×10⁻² part of tetramethylammonium hydroxide as a catalyst were heated at 180° C. in a nitrogen atmosphere to be molten. Thereafter, the degree of vacuum was adjusted to 13.4 kPa over 2 hours, the temperature was raised to 200° C. over 2 hours, and the distilling phenol and the unreacted diol were removed under a reduced pressure of 500 Pa or less to obtain 190 parts of a HD homopolycarbonate oligomer (to be abbreviated as PCHD hereinafter) having a molecular weight of 530 (average number of recurring units of 3.7).

### (2) Copolycarbonate

74 parts of the obtained PCHD, 488 parts of ISS, 750 parts of DPC, and 0.8×10⁻² part of tetramethylammonium hydroxide and 0.6×10⁻⁴ part of sodium hydroxide as catalysts were heated at 180° C. in a nitrogen atmosphere to be molten. Thereafter, the degree of vacuum was adjusted to 13.4 kPa over 30 minutes. After the temperature was raised up to 245° C. at a rate of 60° C./hr and maintained at that temperature for 10 minutes, the degree of vacuum was set to 133 Pa or less over 1 hour. A reaction was carried out under agitation for a total of 6 hours, nitrogen was discharged from the bottom of a reaction tank under increased pressure after the end of the reaction, and the obtained product was cut with a pelletizer to obtain a pellet while it was cooled in a water tank. The number of the recurring units (B-2) in the copolycarbonate was 3.5, and the molecular weight of the unit (B-2) in the copolycarbonate was 500. A resin composition was produced in the same manner as in Example II-1 by using the obtained pellet to carry out the same evaluations as in Example II-1. The evaluation results are shown in Table II.

### Example II-6

The same operation as in Example II-5(1) was carried out except that 94 parts of 2-methyl-1,5-pentanediol (to be abbreviated as MPD hereinafter) was used to obtain 189 parts of an MPD homopolycarbonate oligomer (to be abbreviated as PCMPD hereinafter) having a molecular weight of 520 (average number of recurring units of 3.6).

The same operation and the same evaluations as in Example II-5(2) were carried out except that 74 parts of PCMPD was used in place of PCHD. The number of the recurring units (B-2) in the copolycarbonate was 3.4, and the molecular weight of the unit (B-2) in the copolycarbonate was 490. The results are shown in Table II.

### Example II-7

500 parts of HD, 487 parts of adipic acid and 0.02 part of tetraisopropyl titanate (300 ppm based on the product) were heated at 200° C. under normal pressure while nitrogen was passed therethrough to carry out a condensation reaction while water produced by a reaction was distilled off. When the acid value of the product became 20 or less, the degree of vacuum was gradually raised by a vacuum pump to carry out a reaction for 4 hours so as to obtain 780 parts of polyhexylene adipate diol (to be abbreviated as HAA hereinafter) having a weight average molecular weight of 500. (2) 74 parts of the obtained HAA, 488 parts of ISS, 750 parts of DPC, and 2.4×10⁻² part of tetramethylammonium hydroxide and 1.8×10⁻⁴ part of sodium hydroxide as catalysts were heated at 180° C. in a nitrogen atmosphere to be molten. Thereafter, the degree of vacuum was adjusted to 13.4 kPa over 30 minutes. After the temperature was raised up to 245° C. at a rate of 60° C./hr and maintained at that temperature for 10 minutes, the degree of vacuum was set to 133 Pa or less over 1 hour. A reaction was carried out under agitation for a total of 6 hours, nitrogen was discharged from the bottom of a reaction tank under increased pressure after the end of the reaction, and the obtained product was cut with a pelletizer to obtain a pellet while it was cooled in a water tank. The evaluation results are shown in Table II.

### Example II-8

The same operation and the same evaluations as in Example II-1 were carried out except that 322 parts of ISS, 131 parts of 2,2,4,4-tetramethyl-1,3-cyclobutanediol (to be abbreviated as TMCB hereinafter), 62 parts of ND and 750 parts of DPC were used as raw materials. The results are shown in Table II.

### Example II-9

The same operation and the same evaluations as in Example II-1 were carried out except that 256 parts of ISS, 197 parts of TMCB, 62 parts of ND and 750 parts of DPC were used as raw materials. The results are shown in Table II.

### Example II-10

The same operation and the same evaluations as in Example II-1 were carried out except that 431 parts of ISS, 77 parts of ND and 750 parts of DPC were used as raw materials. The results are shown in Table II.

### Comparative Example II-1

The same operation and the same evaluations as in Example II-1 were carried out except that 501 parts of ISS and 749.7 parts of DPC were used as raw materials. The results are shown in Table II.

### Comparative Example II-2

The same operation and the same evaluations as in Example II-1 were carried out except that 376 parts of ISS, 65 parts of 1,3-propanediol (to be abbreviated as PD hereinafter) and 750 parts of DPC were used as raw materials. The results are shown in Table II.

### Comparative Example II-3

The same operation and the same evaluations as in Example II-1 were carried out except that 400 parts of ISS, 72 parts of 1,5-pentanediol (to be abbreviated as PeD hereinafter) and 750 parts of DPC were used as raw materials. The results are shown in Table II.

### Comparative Example II-4

The same operation and the same evaluations as in Example II-1 were carried out except that 425 parts of ISS, 61 parts of 1,6-hexanediol (to be abbreviated as HD hereinafter) and 750 parts of DPC were used as raw materials. The results are shown in Table II.

### Comparative Example II-5

The same operation and the same evaluations as in Example II-1 were carried out except that 341 parts of ISS, 158 parts of 1,4-cyclohexanedimethanol (to be abbreviated as CHDM hereinafter) and 750 parts of DPC were used as raw materials. The results are shown in Table II.

### Comparative Example II-6

The same operation and the same evaluations as in Example II-1 were carried out except that bisphenol A type polycarbonate resin (Panlite L-1225Z100M of Teijin Chemicals Ltd.) was used to obtain a pellet which was then dried at 120° C. for 5 hours and molded into a plain head lamp lens molded article at a cylinder temperature of 320° C. The results are shown in Table II.

### Comparative Example II-7

The same operation and the same evaluations as in Example II-1 were carried out by using polyacrylic resin (Acrypet MF of Mitsubishi Rayon Co., Ltd.). The results are shown in Table II.

TABLE II
(1/2)

| | | | | | water | | |
|---|---|---|---|---|---|---|---|
| | | | | | absorption | | |
| | | | specific | Tg | coefficient | TW | pencil |
| | composition | | viscosity | ° C. | % | value | hardness |
| Ex. II-1 | ISS/OD | 87/13 | 0.403 | 120 | 1.9 | 2.9 | H |
| Ex. II-2 | ISS/ND | 89/11 | 0.401 | 121 | 1.8 | 3.0 | H |
| Ex. II-3 | ISS/DD | 89/11 | 0.394 | 119 | 1.8 | 3.0 | H |
| Ex. II-4 | ISS/DDD | 90/10 | 0.398 | 120 | 1.7 | 3.1 | H |
| Ex. II-5 | ISS/PCHD | 85/15 | 0.392 | 119 | 1.9 | 2.9 | H |
| Ex. II-6 | ISS/PCMPD | 85/15 | 0.398 | 122 | 1.7 | 3.2 | H |
| Ex. II-7 | ISS/HAA | 95.5/4.5 | 0.392 | 119 | 2.0 | 2.8 | H |
| Ex. II-8 | ISS/TMCB/ND | 63/26/11 | 0.390 | 121 | 1.2 | 3.6 | 2H |
| Ex. II-9 | ISS/TMCB/ND | 50/39/11 | 0.400 | 110 | 1.0 | 3.4 | 2H |
| Ex. II-10 | ISS/ND | 86/14 | 0.402 | 111 | 1.7 | 2.7 | H |
| C. Ex. II-1 | ISS | 100 | 0.394 | 160 | 5.3 | 1.1 | H |
| C. Ex. II-2 | ISS/PD | 75/25 | 0.382 | 116 | 2.4 | 2.2 | F |
| C. Ex. II-3 | ISS/PeD | 80/20 | 0.391 | 125 | 2.8 | 2.2 | F |
| C. Ex. II-4 | ISS/HD | 85/15 | 0.383 | 125 | 3.0 | 2.0 | H |
| C. Ex. II-5 | ISS/CHDM | 68/32 | 0.382 | 120 | 2.3 | 2.5 | F |

| | | | | | | |
|---|---|---|---|---|---|---|
| C. Ex. II-6 | Panlite L-1225Z100M | 0.361 | 145 | 0.4 | 5.4 | 2B |
| C. Ex. II-7 | Acrypet MF | — | 93 | 2.2 | 1.1 | 2H |

Ex.: Example
C. Ex.: Comparative Example
(2/2)

| | | low-temperature impact test | | | | |
|---|---|---|---|---|---|---|
| | dynamic | | brittle | | | |
| | viscoelasticity | | fracture | | weather | |
| | Tmax | fracture | rate | energy | discoloration | head lamp lens |
| | ° C. | morphology | % | J | [symbol] E | molded article |
| Ex. II-1 | −88 | Ductile | 40 | 22 | 0.7 | satisfactory |
| Ex. II-2 | −90 | Ductile | 0 | 48 | 0.7 | satisfactory |
| Ex. II-3 | −89 | Ductile | 10 | 43 | 0.7 | satisfactory |
| Ex. II-4 | −89 | Ductile | 10 | 45 | 0.8 | satisfactory |
| Ex. II-5 | −86 | Ductile | 20 | 32 | 0.7 | satisfactory |
| Ex. II-6 | −86 | Ductile | 20 | 38 | 0.9 | satisfactory |
| Ex. II-7 | −85 | Ductile | 20 | 39 | 0.8 | satisfactory |
| Ex. II-8 | −89 | Ductile | 20 | 40 | 0.7 | satisfactory |
| Ex. II-9 | −88 | Ductile | 20 | 39 | 0.8 | satisfactory |
| Ex. II-10 | −90 | Ductile | 0 | 46 | 0.7 | satisfactory |
| C. Ex. | −36 | Brittle | 100 | 2 | 1.6 | low-temperature |
| II-1 | | | | | | impact properties: × |
| C. Ex. | −48 | Brittle | 100 | 4 | 0.7 | low-temperature |
| 11-2 | | | | | | impact properties: × |
| C. Ex. | −68 | Brittle | 100 | 3 | 0.8 | low-temperature |
| 11-3 | | | | | | impact properties: × |
| C. Ex. | −72 | Brittle | 100 | 6 | 1.1 | low-temperature |
| 11-4 | | | | | | impact properties: × |
| C. Ex. | — | Brittle | 80 | 20 | 0.7 | low-temperature |
| 11-5 | | | | | | impact properties: × |
| C. Ex. | −83 | Ductile | 0 | 68 | 4.6 | weather resistance, |
| 11-6 | | | | | | surface hardness: × |
| C. Ex. | — | Brittle | 100 | 1 | — | Impact properties: × |
| 11-7 | | | | | | |

Ex.: Example
C. Ex.: Comparative Example
×: not satisfactory

### Examples III-1 to III-4, Comparative Examples III-1 to II-5

The following examples are provided for the purpose of further illustrating the invention which relates to a plastic lens. However, the present invention is not limited to these examples. Evaluations were made by the following methods.

### (1) Specific Viscosity

The pellet was dissolved in methylene chloride to a concentration of about 0.7 g/dL so as to measure the specific viscosity of the resulting solution at 20° C. with an Ostwald viscometer (name of device: RIGO AUTO VISCOSIMETER TYPE VMR-0525χPC). The specific viscosity ηₛₚ is obtained from the following equation.

ηₛₚ=t/t₀−1

t: flow time of sample solution
t₀: flow time of solvent alone

### (2) Glass Transition Temperature (Tg)

The pellet was measured with the DSC (model DSC2910) of TA Instruments.

### (3) Photoelastic Constant

A film having a width of 1 cm and a length of 6 cm was prepared, and the phase difference under no load and the phase difference of light having a wavelength of 550 nm under loads of 1N, 2N and 3N of the film were measured with the M220 spectroscopic ellipsometer of JASCO Corporation to calculate (phase difference)×(film width)/(load).

### (4) Total Light Transmittance

After the pellet was dried at 105° C. for 5 hours with hot air, it was molded into a three-stage plate having a width of 50 mm, a length of 90 mm and a thickness of 3.0 mm (length of 20 mm), 2.0 mm (length of 45 mm) and 1.0 mm (length of 25 mm) from the gate side and an arithmetic average roughness (Ra) of 0.03 μm at a molding temperature of 240° C., a mold temperature of 80° C. and a molding cycle of 50 seconds by using an injection molding machine (JSW J-75EIII of The Japan Steel Works, Ltd.).

The total light transmittance of a 2.0 mm-thick part of the three-stage plate was measured by using the Haze Meter NDH 2000 of Nippon Denshoku Industries Co., Ltd. in accordance with IS013468.

### (5) Pencil Hardness

The pellet was molded into a 2 mm-thick rectangular plate at a cylinder temperature of 240° C., a mold temperature of 80° C. and a molding cycle of 1 minute by using the JSW J-75EIII of The Japan Steel Works, Ltd. to measure the JIS K5600-based scratch hardness (pencil method) of the molded test piece.

### (6) Appearance of Lens

Transmitted light and reflected light were applied to a plastic lens under a 3-wavelength type white light fluorescent lamp to visually check and judge the degree of an interference fringe and whitened state.

### (7) In-Plane Phase Difference of Lens

A spectacle lens having a thickness of 2.0 mm and a diameter of 50 mm was formed by injection molding to measure its phase difference and slow axis by using the KOBRA-CCD/XY30P small-area phase difference measuring instrument of Oji Scientific Instruments.

### (8) Weather Resistance

After the plastic lens obtained in (7) above was exposed to a black panel temperature of 63° C. and a humidity of 50% for 1,000 hours at a cycle time of 120 minutes which consisted of 18 minutes of water spray and 102 minutes of no water spray by using a sunshine weather meter (WEL-SUN: HC-B of Suga Test Instruments Co., Ltd.), the color (ΔYI) and appearance crack of a 2.0 mm-thick part of the plastic lens were checked and judged.

### (9) Impact Strength

A spectacle lens having a thickness of 2.0 mm and a diameter of 50 mm was formed by injection molding to check the degrees of its “breakage, chipping and cracking” by dropping steel balls (68 g, 357 g) from a height of 127 cm at 25° C. and −20° C. in accordance with ANSI Z87.1.

### Example III-1

### Copolycarbonate

463.72 parts of isosorbide (to be abbreviated as ISS hereinafter), 41.24 parts of 1,9-nonanediol (to be abbreviated as ND hereinafter), 749.70 parts of diphenyl carbonate (to be abbreviated as DPC hereinafter), and 3.0×10⁻² part of tetramethylammonium hydroxide and 1.0×10⁻⁴ part of sodium hydroxide as catalysts were heated at 170° C. in a nitrogen atmosphere to be molten. After it was confirmed that they were molten, an EI reaction step was started. After the start of decompression, decompression was carried out for 70 minutes to ensure that the final degree of vacuum became 13.4 kPa, and that degree of vacuum was maintained after 13.4 kPa was reached. At the same as the start of decompression, the temperature was raised at a rate of 10° C./hr until the final polymer temperature became 190° C. After the final polymer temperature reached 190° C., a vacuum degree of 13.4 kPa and a polymer temperature of 190° C. were maintained for 10 minutes until 80% of the theoretical amount of phenol was distilled off.

After it was confirmed that 80% of phenol was distilled off, a PA reaction step (pre-step) was started. The temperature was raised at a rate of 0.5° C./hr until the final polymer temperature became 220° C. Decompression was carried out for 60 minutes to ensure that the final degree of vacuum became 3 kPa along with the elevation of temperature.

Subsequently, the PA reaction step (post-step) was started. In the post-step, the temperature was raised at a rate of 1° C./min to ensure that the final polymer temperature became 240° C. Decompression was carried out for 20 minutes to ensure that the final degree of vacuum became 134 Pa along with the elevation of temperature. When a predetermined agitation power value was reached, the reaction was terminated, a tetrabutyl phosphonium salt of dodecylbenzenesulfonic acid was added in an amount 2 times larger than the total molar amount of the catalysts to deactivate the catalysts, nitrogen was discharged from the bottom of a reaction tank under increased pressure, and the obtained product was cut with a pelletizer to obtain a pellet while it was cooled in a water tank.

### (Resin Composition)

The obtained pellet, 2-(3-tert-butyl-5-methyl-2-hydroxyphenyl)-5-chloro-2H-benzotriazole which is a benzotriazole type ultraviolet absorbent as an ultraviolet absorbent, ADK STAB LA-77Y (of ADEKA Corporation) which is a secondary amine compound as an optical stabilizer and Irgafos 168 (manufactured by BASF; tris(2,6-di-tert-butylphenyl)phosphite) which is a phosphorus-based stabilizer as an antioxidant were uniformly mixed together, and the resulting mixture was injected into an extruder to obtain the resin composition shown in Table III. A vented double-screw extruder having a diameter of 30 mm (TEX30α-35BW-3V of The Nippon Steel Works, Ltd.) was used as the extruder. As extrusion conditions, the discharge rate was set to 30 to 40 kg/hr, the screw revolution was set to 250 rpm, the vacuum degree of the vent was set to 3 kPa and the extrusion temperature from the first feed port to the dice part was set to 230° C. to obtain a pellet.

### (Spectacle Lens)

After the obtained pellet was dried at 105° C. for 12 hours, its physical properties were evaluated. Further, the obtained copolycarbonate pellet was injection compression molded at a cylinder temperature of 220 to 240° C. and a mold temperature of 70 to 100° C. by using a mold for spectacle lenses to produce a spectacle lens. This lens had high transparency and good appearance. The results obtained by carrying out falling ball tests on this lens are shown in Table III.

### Example III-2

The melt polymerization of the copolycarbonate was carried out in the same manner as in Example III-1 except that 446.18 parts of ISS and 60.49 parts of ND were used, and the polymer after the reaction was pelletized. The obtained pellet and the components shown in Table III were uniformly mixed together, the resulting mixture was injected into an extruder to produce the resin composition shown in Table III, and the composition was injection compression molded to produce a spectacle lens in the same manner as in Example III-1. This lens had high transparency and good appearance. The results obtained by carrying out falling ball tests on this lens are shown in Table III.

### Example III-3

The melt polymerization of the copolycarbonate was carried out in the same manner as in Example III-1 except that 350.93 parts of ISS and 148.44 parts of cyclohexanedimethanol (to be abbreviated as CHDM hereinafter) were used, and the polymer after the reaction was pelletized. The obtained pellet and the components shown in Table III were uniformly mixed together, the resulting mixture was injected into an extruder to produce the resin composition shown in Table III, and the composition was injection compression molded to produce a spectacle lens in the same manner as in Example III-1. This lens had high transparency and good appearance. The results obtained by carrying out falling ball tests on this lens are shown in Table III.

### Example III-4

The melt polymerization of the copolycarbonate was carried out in the same manner as in Example III-1, and the polymer after the reaction was pelletized. The obtained pellet was uniformly mixed with Irgafos 168 as an antioxidant, and the obtained resin composition was injection compression molded to obtain a spectacle lens. The results obtained by carrying out falling ball tests on this lens are shown in Table III.

It is understood that the polycarbonate lens produced in Example 4 is inferior in weather resistance to the coplycarbonate lenses produced in Examples III-1 to III-3 but equivalent in other properties.

### Comparative Example III-1

The melt polymerization of the copolycarbonate was carried out in the same manner as in Example III-1 except that 426.13 parts of ISS and 60.84 parts of 1,6-hexanediol (to be abbreviated as HD hereinafter) were used, and the polymer after the reaction was pelletized. The obtained pellet and the components shown in Table III were uniformly mixed together, the resulting mixture was injected into an extruder to produce the resin composition shown in Table III, and the composition was injection compression molded to produce a spectacle lens in the same manner as in Example III-1. The results obtained by carrying out falling ball tests on this lens are shown in Table III.

### Comparative Example III-2

The melt polymerization of the copolycarbonate was carried out in the same manner as in Example III-1 except that 340.90 parts of ISS and 250.68 parts of bisphenol A (to be abbreviated as BPA hereinafter) were used, and the polymer after the reaction was pelletized. The obtained pellet and the components shown in Table III were uniformly mixed together, the resulting mixture was injected into an extruder to produce the resin composition shown in Table III, and the composition was injection compression molded to produce a spectacle lens in the same manner as in Example III-1. The results obtained by carrying out falling ball tests on this lens are shown in Table III.

### Comparative Example III-3

The melt polymerization of the copolycarbonate was carried out in the same manner as in Example III-1 except that 501.32 parts of ISS and 749.70 parts of diphenyl carbonate were used, and the polymer after the reaction was pelletized. The obtained pellet and the components shown in Table III were uniformly mixed together, the resulting mixture was injected into an extruder to produce the resin composition shown in Table III, and the composition was injection compression molded to produce a spectacle lens in the same manner as in Example III-1. The results obtained by carrying out falling ball tests on this lens are shown in Table III.

It is understood that the polycarbonate lenses produced in Comparative Examples III-1 to III-3 are inferior in impact strength to the polycarbonate lenses produced in Examples III-1 to III-3. It is also understood that they have bad balance among lens properties, for example, one having high lens birefringence, one having low weather resistance and one having low surface hardness.

### Comparative Example III-4

A spectacle lens was produced in the same manner as in Example III-1 by using the Panlite (registered trademark) AD5503 (pellet) of Teijin Chemicals Ltd. which is a bisphenol A (BPA) polycarbonate. The results obtained by carrying out falling ball tests on this lens are shown in Table III.

It is understood that the polycarbonate lens produced in Comparative Example III-4 is inferior in lens properties such as a high photoelastic constant and low weather resistance to the copolycarbonate lenses produced in Examples III-1 to III-3. It is also understood that it is inferior in surface hardness as well.

### Comparative Example III-5

Evaluation results obtained by using polyacrylic resin (Acrypet MF of Mitsubishi Rayon Co., Ltd.) are shown in Table III.

It is understood that the polyacrylic resin lens produced in Comparative Example 5 is inferior in impact strength to the copolycarbonate lenses produced in Examples III-1 to III-3.

TABLE III

| | | ISS/ND | ISS/ND | ISS/CHDM | ISS/ND | |
|---|---|---|---|---|---|---|
| | | Example | Example | Example | Example | |
| | substrate | III-1 | III-2 | III-3 | III-4 | |
| Isosorbide | mol % | 92.5 | 89 | 70 | 92.5 | |
| Diol | mol % | (ND) | (ND) | (CHDM) | (ND) | |
| | | 7.5 | 11 | 30 | 7.5 | |
| Ultraviolet | Part by weight | 0.4 | 0.4 | 0.4 | — | |
| absorbent | | | | | | |
| Optical stabilizer | Part by weight | 0.1 | 0.1 | 0.1 | — | |
| Phosphorus-based | Part by weight | 0.1 | 0.1 | 0.1 | 0.1 | |
| heat stabilizer | | | | | | |
| Specific viscosity | | 0.34 | 0.34 | 0.38 | 0.34 | |
| Glass transition | ° C. | 135 | 121 | 120 | 135 | |
| temperature | | | | | | |
| Total light | % | 91 | 91 | 92 | 91 | |
| transmittance | | | | | | |
| Photoelastic | ×10⁻¹²Pa⁻¹ | 16 | 15 | 20 | 16 | |
| constant | | | | | | |
| Pencil hardness | — | H | H | F | H | |
| Lens appearance | degree of | very low | very low | very low | very low | |
| | interference | | | | | |
| | fringe | | | | | |
| Phase difference of | nm | 35 | 34 | 38 | 35 | |
| lens | | | | | | |
| Weather resistance | SWOM1000h [symbol] JYI | 1 | 1 | 1 | cracked | |
| of lens | | | | | | |
| Impact properties at | falling ball | no | no | no | no breakage | |
| indoor temperature | test from 1.27 m | breakage | breakage | breakage | | |
| (25° C.) | (68 g) | | | | | |
| Impact properties at | falling ball | no | no | no | no breakage | |
| indoor temperature | test from 1.27 m | breakage | breakage | breakage | | |
| (25° C.) | (357 g) | | | | | |
| Low-temperature | falling ball | no | no | cracked | no breakage | |
| impact properties | test from 1.27 m | breakage | breakage | | | |
| (−20° C.) | (357 g) | | | | | |
| | | ISS/HD | ISS/BPA | ISS homo | PC | PMMA |
| | | C. Ex. | C. Ex. | C. Ex. | C. Ex. | C. Ex. |
| | substrate | III-1 | III-2 | III-3 | III-4 | III-5 |
| Isosorbide | mol % | 85 | 68 | 100 | 0 | — |
| Diol | mol % | (HD) | (BPA) | 0 | (BPA) | — |
| | | 15 | 32 | | 100 | |
| Ultraviolet | Part by | 0.4 | 0.4 | 0.4 | — | — |
| absorbent | weight | | | | | |
| Optical | Part by | 0.1 | 0.1 | 0.1 | — | — |
| stabilizer | weight | | | | | |
| Phosphorus-based | Part by | 0.1 | 0.1 | 0.1 | 0.1 | — |
| heat stabilizer | weight | | | | | |
| Specific | | 0.25 | 0.27 | 0.26 | 0.28 | — |
| viscosity | | | | | | |
| Glass transition | ° C. | 125 | 152 | 163 | 143 | 93 |
| temperature | | | | | | |
| Total light | % | 92 | 91 | 92 | 89 | 92 |
| transmittance | | | | | | |
| Photoelastic | ×10⁻¹²Pa⁻¹ | 18 | 38 | 15 | 90 | −3 |
| constant | | | | | | |
| Pencil hardness | — | HB | B | H | 4B | 2H |
| Lens appearance | degree of | very low | very low | very low | remarkable | very low |
| | interference | | | | | |
| | fringe | | | | | |
| Phase difference of | nm | 30 | 48 | 33 | 80 | 3 |
| lens | | | | | | |
| Weather resistance | SWOM1000h [symbol] YI | 1 | 10 | 1 | 12 | 0 |
| of lens | | | | | | |
| Impact properties | falling ball | cracked | chipped | chipped | no | breakage |
| at indoor | test from 1.27 m | | | | breakage | |
| temperature (25° C.) | (68 g) | | | | | |
| Impact properties | falling ball | breakage | breakage | breakage | no | breakage |
| at indoor | test from 1.27 m | | | | breakage | |
| temperature | (357 g) | | | | | |
| (25° C.) | | | | | | |
| Low-temperature | falling ball | breakage | breakage | breakage | no | breakage |
| impact properties | test from 1.27 m | | | | breakage | |
| (−20° C.) | (357 g) | | | | | |

C. Ex.: Comparative Example

### EFFECT OF THE INVENTION

The molded article of the present invention is excellent in heat resistance, weather resistance, low water absorption, surface hardness and low-temperature impact properties. The resin window of the present invention is excellent in heat resistance, weather resistance, low water absorption, surface hardness and low-temperature impact properties. The lamp lens for vehicles of the present invention is excellent in heat resistance, weather resistance, surface hardness, low water absorption and low-temperature impact properties. The plastic lens of the present invention is excellent in balance among heat resistance, cold resistance, transparency, impact strength, scratch resistance and optical properties.

### INDUSTRIAL APPLICABILITY

The molded article of the present invention is useful as a resin window, a lamp lens for vehicles or a plastic lens.

The resin window of the present invention is useful as a window for airplanes, vehicles and automobiles, a window for sunroofs and construction machines, or a window for buildings, houses and greenhouses. The lamp lens for vehicles of the present invention is widely useful as a head lamp lens, rear lamp lens, direction indicator lamp lens or room lamp lens for automobiles, motorcycles and trains. The plastic lens of the present invention is useful as a spectacle lens or a sunglass lens.

### EXPLANATION OF REFERENCE NUMERALS

1 head lamp lens body
2 domed part of lens (projected surface corresponds to a movable mold)
3 peripheral part of lens
4 gate of molded article (width of 30 mm, thickness of gate part of 4 mm)
5 sprue (diameter of gate part of 7 mm)
6 diameter of peripheral part of lens (220 mm)
7 diameter of domed part of lens (200 mm)
8 height of domed part of lens (20 mm)
9 thickness of lens molded article (4 mm)

1. A molded article formed from a polycarbonate which contains a unit (A) represented by the following formula (A) in an amount of 50 mol % or more based on the total of all recurring units and has a maximum impact energy of 20 J or more in a high-speed surface impact test based on ASTM D3763 in a −20° C. environment and a brittle fracture rate of 50% or less.

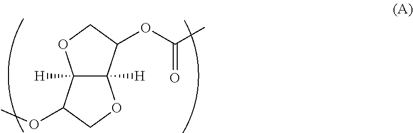

2. The molded article according to claim 1, wherein the polycarbonate further contains a unit (B-1) represented by the following formula (B-1) and has (i) a total content of the unit (A) and the unit (B-1) of 80 mol % or more based on the total of all recurring units and (ii) a (A/(B-1)) molar ratio of the unit (A) to the unit (B-1) of 60/40 to 95/5. 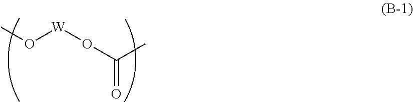
(wherein W is an alkylene group having 8 to 12 carbon atoms.)

3. The molded article according to claim 1, wherein the polycarbonate further contains a carbonate unit (B-2) derived from at least one compound selected from the group consisting of an aliphatic diol compound and an alicyclic diol compound and has (i) a blocking property, (ii) a total content of the unit (A) and the unit (B-2) of 80 mol % or more based on the total of all recurring units and (iii) a (A/(B-2)) molar ratio of the unit (A) to the unit (B-2) of 60/40 to 95/5.

4. The molded article according to claim 1, wherein the polycarbonate further contains a unit (B-3) represented by the following formula and has (i) a total content of the unit (A) and the unit (B-3) of 80 mol % or more based on the total of all recurring units and (ii) a (A/(B-3)) molar ratio of the unit (A) to the unit (B-3) of 50/50 to 95/5. 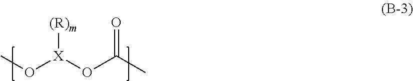
(wherein X is an alkylene group having 3 to 20 carbon atoms or cycloalkylene group having 3 to 20 carbon atoms, R is an alkyl group having 1 to 20 carbon atoms or cycloalkyl group having 3 to 20 carbon atoms, and “m” is an integer of 1 to 10.)

5. The molded article according to claim 1, wherein the specific viscosity measured with a 20° C. methylene chloride solution of the polycarbonate is 0.23 to 0.60.

6. The molded article according to claim 1, wherein the glass transition temperature of the polycarbonate is 80 to 160° C.

7. The molded article according to claim 1, wherein the temperature (Tmax) at which the loss tangent (tan σ) of dynamic viscoelasticity measurement of the polycarbonate becomes maximum is −73° C. or lower.

8. The molded article according to claim 1, wherein the saturated water absorption coefficient of the polycarbonate is 2.5% or less.

9. The molded article according to claim 1, wherein the pencil hardness measured in accordance with JIS K5600-5-4 of the polycarbonate is at least HB.

10. The molded article according to claim 1, wherein the glass transition temperature (Tg° C.) of the polycarbonate is 100 to 160° C., and its relationship with saturated water absorption coefficient (Wa %) satisfies the following expression (I).
2.5≦TW value=Tg×0.04−Wa (I)

11. The molded article according to claim 1 which is a resin window or a lamp lens for vehicles.

12. A plastic lens which is formed from a polycarbonate containing (i) a carbonate unit (A) represented by the following formula and having (ii) a specific viscosity measured with a 20° C. methylene chloride solution of 0.3 to 0.8, (iii) a glass transition temperature of 100° C. or higher, (iv) a pencil hardness of at least HB and (v) a total light transmittance of 80% or more and which (vi) does not crack with a falling ball having a weight of at least 68 g in a falling ball test based on ANSI Z87.1 standard at 25° C. and (vii) has an in-plane phase difference of 50 nm or less at a thickness of 2.0 mm.

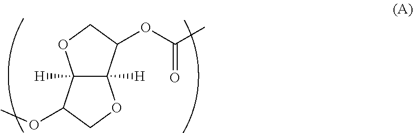

13. The plastic lens according to claim 12, wherein the polycarbonate contains a carbonate unit (A) represented by the above formula and a carbonate unit (B-2) derived from at least one compound selected from the group consisting of an aliphatic diol compound and an alicyclic diol compound and has a (A/(B-2)) molar ratio of the unit (A) to the unit (B-2) of 15/85 to 95/5.

14. The plastic lens according to claim 12, wherein the polycarbonate has a glass transition temperature of 120 to 140° C.

15. The plastic lens according to claim 12, wherein the polycarbonate has a photoelastic coefficient absolute value of 30×10⁻¹² Pa⁻¹ or less.

16. The plastic lens according to claim 12 which does not crack with a falling ball having a weight of at least 357 g in a falling ball test based on ANSI Z87.1 standard at 25° C.

17. The plastic lens according to claim 12 which does not crack with a falling ball having a weight of at least 357 g in a falling ball test based on ANSI Z87.1 standard at −20° C.
